(19) United States
(12) Patent Application Publication
(10) Pub. No.: US 2022/0067869 A1
(43) Pub. Date: Mar. 3, 2022

(54) Tracking Objects Throughout a Multi-Modal Transportation Service

(71) Applicant: Uber Technologies, Inc., San Francisco, CA (US)

(72) Inventors: Adam Warmoth, San Francisco, CA (US); Santo Francisco Brocato, Austin, TX (US)

(21) Appl. No.: 17/463,856

(22) Filed: Sep. 1, 2021

Related U.S. Application Data
(60) Provisional application No. 63/073,184, filed on Sep. 1, 2020.

(51) Int. Cl. G06Q 50/30; G06Q 10/06; G06Q 50/28

(52) U.S. Cl. CPC G06Q 50/30; G06Q 10/06315; B60W 40/12; B60W 2420/52; B60W 2420/54; G06Q 50/28

(57) ABSTRACT

Systems and methods for tracking objects throughout a multi-modal transportation service are provided. A system can obtain itinerary data identifying a number of transitioning point along a multi-leg transportation service. The system can obtain object data and associate a number of objects identified by the object data with a rider travelling along the multi-leg transportation service. The system can periodically determine the location of the objects while the rider transitions between each leg of the transportation service. The system can determine and initiate an object-check action based on the location of the objects. The object-check action can include facilitating a subsequent leg of the transportation service by providing information corresponding the subsequent leg when the objects are not separated from the rider or blocking the initiation of the subsequent leg or the termination of the current leg when an object is separated from the rider.

### RELATED APPLICATIONS

This application claims priority to and the benefit of U.S. Provisional Patent Application No. 63/073,184, filed Sep. 1, 2020, which is hereby incorporated by reference in its entirety.

### FIELD

The present disclosure relates generally to vehicle services and, more particularly, facilitating multi-modal vehicle services.

### BACKGROUND

A wide variety of modes of transport are available within cities. For example, people can walk, ride a bike, drive a car, take public transit, or use a ride sharing service. As population densities and demand for land increase, however, many cities are experiencing problems with traffic congestion and the associated pollution. Consequently, there is a need to expand the available modes of transport in ways that can reduce the amount of traffic without requiring the use of large amounts of land. Air travel, water travel, and underground travel within cities can reduce travel time over purely ground-based approaches and alleviate problems associated with traffic congestion. Multi-modal itineraries that combine a number of different transportation modalities provide opportunities to expand transport networks for cities and metropolitan areas. However, the transfer from one modality to another can present technical problems.

### SUMMARY

Aspects and advantages of implementations of the present disclosure will be set forth in part in the following description, or may be learned from the description, or may be learned through practice of the implementations.

Aspects of the present disclosure are directed to computing system including one or more processors and one or more tangible, non-transitory, computer readable media that collectively store instructions that when executed by the one or more processors cause the computing system to perform operations. The operations include obtaining itinerary data indicative of a multi-modal transportation itinerary for facilitating a transportation service for a rider. The itinerary data can identify at least a first transportation leg, a second transportation leg, and a third transportation leg. The operations can include obtaining object data indicative of one or more objects accompanying the rider during the transportation service. The operations can include generating a user-object profile for the rider. The user-object profile can be indicative of an association between the object data and the rider. The operations can include identifying, by the computing system, a completion of at least one transportation leg of the multi-modal transportation itinerary. The operations can include determining, by the computing system, an object-check action based, at least in part, on the at least one transportation leg and the user-object profile. And, the operations can include initiating, by the computing system, the object-check action.

Another aspect of the present disclosure is directed to a computer-implemented method. The method can include obtaining itinerary data indicative of a multi-modal transportation itinerary for facilitating an alternative transport of a rider. The itinerary data can identify at least a first transportation leg, a second transportation leg, and a third transportation leg. The method can include obtaining user-object profile data associated with the rider. The user-object profile data can be indicative of an association between an object and the rider. The method can include obtaining data indicative of a first object-check action determined based, at least in part, on the first transportation leg, the user-object profile data, and first leg object location data associated with the object. The method can include identifying a checking-in operation associated with the rider. The method can include determining a second object-check action based, at least in part, on the first object-check action and the checking-in operation associated with the rider. And, the method can include initiating the second object-check action.

Yet another aspect of the present disclosure is directed to one or more tangible, non-transitory computer-readable media storing computer-readable instructions that when executed by one or more processors cause the one or more processors to perform operations. The operations can include obtaining itinerary data indicative of a multi-modal transportation itinerary for facilitating a transportation service for a rider. The itinerary data can identify at least a first transportation leg, a second transportation leg, and a third transportation leg. The operations can include obtaining object data indicative of an object accompanying the rider during the transportation service. The operations can include generating a user-object profile for the rider. The user-object profile can be indicative of an association between the object data and the rider. The operations can include obtaining object location data associated with one or more of the first transportation leg, the second transportation leg, or the third transportation leg. The object location data can be indicative of a relative location of the object to the rider. The operations can include determining a concluding object-check action based, at least in part, on the user-object profile and the object location data. And, the operations can include initiating the concluding object-check action.

Other aspects of the present disclosure are directed to various systems, apparatuses, non-transitory computer-readable media, user interfaces, and electronic devices.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing system according to example embodiments of the present disclosure;

FIG. 2 depicts a graphical diagram of an example set of flight plans between an example set of transportation nodes according to example embodiments of the present disclosure;

FIG. 3 depicts a graphical diagram of an example transportation node according to example embodiments of the present disclosure;

FIG. 4 depicts a graphical diagram of an example multi-modal transportation itinerary according to example embodiments of the present disclosure;

FIG. 5 depicts a dataflow diagram for initiating an object-check action according to example implementations of the present disclosure;

FIG. 6 depicts an object check user interface according to aspects of the present disclosure;

FIG. 7 depicts a separated object user interface according to aspects of the present disclosure;

FIG. 8 depicts an object recovery user interface according to aspects of the present disclosure;

FIG. 9 depicts a flow diagram of an example method for initiating an object check according to example embodiments of the present disclosure;

FIG. 10 depicts another flow diagram of another example method for initiating an object check according to example embodiments of the present disclosure;

FIG. 11 depicts a third flow diagram of another example method for initiating an object check according to example embodiments of the present disclosure; and

FIG. 12 depicts a block diagram of an example computing system according to example embodiments of the present disclosure.

### DETAILED DESCRIPTION

Aspects of the present disclosure are directed to improved systems and methods for tracking objects throughout a multi-modal transportation service. The multi-modal transportation service can include a multi-leg transportation service that utilizes a plurality of different transportation modalities across a number of different transportation mediums such as, for example, one or more different ground-based modalities (e.g., manually driven motor vehicles, autonomously driven motor vehicles, light electric vehicles, etc.), one or more different aerial-based modalities (e.g., electric vertical take-off and landing aircraft, airplanes, drones, etc.), one or more different water-based modalities (e.g., cruise ships, ferries, etc.), one or more underground-based modalities (e.g., subway systems, etc.), and/or any other transportation modality capable of transporting people or goods (e.g., including public transit modality, etc.). As an example, a multi-leg transportation service can include a multi-modal transportation itinerary that includes a first, second, and/or third leg each performed via the same or different transportation modality. As one example, the first and second legs can be performed via a ground-based vehicle modality (e.g., public transit, autonomous ground vehicle, etc.) and the second leg can be performed via an aerial or water-based modality.

Aspects of the present disclosure are directed to a computing system configured to create and/or maintain a multi-modal transportation itinerary responsive to a rider request for a multi-modal transportation service. For instance, a service entity can manage and/or coordinate a plurality of different types of vehicles to provide services to a plurality of riders via a transportation platform. By way of example, a rider may generate a service request for transportation from an origin location to a destination location. At times, the rider request can include information associated with one or more objects (e.g., luggage, personal items (purse, etc.), bags (e.g., grocery bags, etc.), etc.) to accompany the rider during the requested service. A computing system associated with the service entity (e.g., a cloud-based operations computing, etc.) can obtain data indicative of the service request and/or object(s) to accompany the rider and generate an itinerary to facilitate transporting the rider and/or object(s) from the origin location to the destination location. The itinerary can be a multi-modal transportation itinerary that includes at least two types of transportation (e.g., via different modalities and/or mediums) such as, for example, a ground-based vehicle transportation, an aerial-based vehicle transportation, an underground-based vehicle transportation, a water-based vehicle transportation, etc. For example, the itinerary can include three legs: a first leg that includes a ground-based vehicle transporting the rider from the origin location (e.g., a home, etc.) to a first transport facility (e.g., associated with an aerial, water, or underground modality); a second leg (e.g., an alternative modality portion) that includes an aerial vehicle, a water vehicle, or an underground vehicle transporting the rider from the first transport facility to a second transport facility; and/or a third leg that includes another ground-based vehicle transporting the rider from the second transport facility to the destination location (e.g., a conference center). Transportation service(s) can be provided in accordance with the multi-modal transportation itinerary to facilitate the transportation of the rider and/or object(s) accompanying the rider from the origin location to the destination location. During the transportation service(s) the rider can be separated from the object(s) intended to accompany the rider. To prevent the separation of the such object(s), the computing system of the present disclosure can track the object(s) and/or rider during the transportation service(s).

The technology of the present disclosure provides an improved approach for facilitating the transportation for a rider with accompanying object(s), while also providing recovery options in the event that an object is separated from the rider. To do so, a computing system can obtain object information (e.g., quantity, shape, color, size, etc.) and/or itinerary information associated with a multi-modal transportation itinerary for facilitating the transportation of a rider and/or an object accompanying the rider and generate a user-object profile associating the accompanying object with the rider for the multi-modal transportation itinerary. The computing system can obtain data indicative of the progress of the multi-modal transportation itinerary and perform an object check at times in which the separation of an object from a rider can be prevalent (e.g., at the completion of a transportation leg, during a transition from one transportation leg to another, etc.). The object check can include determining the relative location of the object with respect the rider or the itinerary. The computing system can determine that the object has been separated from the rider in the event that object is left on a vehicle (e.g., car, aircraft, boat, subway, etc.) associated (e.g., assigned to facilitate) with a previous transportation leg. In such a case, the computing system can initiate one or more blocking actions (e.g., stopping an operator of the previous vehicle from providing another transportation service, preventing the rider from progressing to the next transportation leg, etc.) and/or provide information (e.g., a request to retrieve the separated objects, alternative options (e.g., delivery at a later time, pick up at a customer service facility, etc.) to retrieve the separated objects, etc.) indicative of the separated object to various device(s) (e.g., rider device(s), the operator device(s) such as an operator device of the previous vehicle, infrastructure device(s), etc.) associated with the multi-modal transportation itinerary. At times, the computing system can generate an alternative itinerary for object recovery and provide information (e.g., cost projections, time projections, methods for recovery, etc.) indicative of the object recovery to the rider.

In this manner, the systems and methods of the present disclosure can enable a computing system to track one or more object(s) accompanying a rider across a multi-modal transportation service with a number of transitions between transportation modalities. This, in turn, enables the system to selectively facilitate one or more transportation legs of the service based on the relative location of the object and rider. In addition, the system enables the seamless recovery of separated objects in the event an object is separated from a rider during the transportation service. This can provide a more efficient approach to facilitating transportation services in general, and, specifically, for facilitating transportation services for a rider with one or more accompanying objects, thereby saving processing and/or memory resources devoted to the recovery of objects separated during the course of transportation services.

More particularly, a service entity can be associated with an operations computing system (e.g., a cloud-based computing system, etc.) that is configured to manage, coordinate, and/or dynamically adjust a multi-modal transportation service via a transportation platform. The multi-modal transportation service can include a plurality of transportation legs, one of which (e.g., a second transportation leg) can include a transport of a rider through a medium or modality different from a ground vehicle. The transport, for example, can include an aerial transport, a water transport, a rail transport, or any other alternative means of transportation. For example, the computing system can obtain a request for a transportation service. The computing system can obtain the request from a rider device associated with the rider of the transportation platform. The rider device, for example, can include any type of computing device such as a smartphone, tablet, hand-held computing device, wearable computing device, embedded computing device, navigational computing device, etc. The rider device can include one or more communication interfaces configured to communicate (e.g., via one or more networks such as local area networks, wide area networks, the Internet, secure networks, cellular networks, mesh networks, etc.) with the transportation platform.

In some implementations, the rider device can generate the request. For instance, the rider device can include a software application running on the rider device. The software application, for example, can be associated with the rider and/or the transportation platform. For example, the rider can be associated with an account on the transportation platform and/or the software application can allow the rider to book a multi-model transportation service of the service entity using the rider's account (e.g., to facilitate payment, maintain usage history, apply discounts, identify preferences, identify objects to accompany the rider, etc.). The rider can interact with the software application running on the rider device (e.g., via a user interface) to generate the request for the transportation service and communicate with the transportation platform during the transportation service.

A transportation platform, for example, can include an computing system communicatively connected over a network to a plurality of riders (e.g., via one or more rider devices, etc.), a plurality service providers (e.g., via one or more service provider devices), a plurality of infrastructure personnel (e.g., via one or more infrastructure devices), etc. The transportation platform can be configured to leverage transportation capabilities of the plurality of service providers to schedule and/or facilitate a multi-modal transportation service for the rider and/or one or more object(s) accompanying the rider. The computing system can be configured to coordinate the multi-modal transportation service for the transportation platform.

For example, the computing system can obtain a request from a rider requesting a transportation service for the rider and/or one or more object(s) to accompany the rider from an origin location to a destination location. By way of example, the rider can interact with the software application running on the rider device to initiate the request. In some instances, unless specified otherwise, the origin of the transportation service can be assumed to be a current location of the rider (e.g., as indicated by location data such as global positioning system (GPS) data received from the rider device and/or as input by the rider). The rider can also supply a desired destination (e.g., by typing the destination into a text field which may, for example, provide suggested completed entries while the rider types).

In some implementations, the request can also specify an “arrive by” date and/or time at which the rider desires to arrive at the requested destination. Thus, the rider can specify when the rider would like to arrive at the destination. In other implementations, the request can indicate a “depart at” date and/or time that the rider would like to depart. In some examples, the “depart at” date and/or time can be assumed to be the current date and/or time unless specified otherwise. The rider can also provide entries for any number of additional characteristics that the rider would like the transportation service to meet. For example, additional entries can specify a required number of seats, a preferred vehicle type (e.g., luxury vs. economy, humanly-operated vs. autonomous, etc.), an estimated payload weight (e.g., passengers and/or object weight, etc.), a preferred payload capacity (e.g., so that the vehicle accommodates the weight of any objects accompanying the rider, etc.), maximum price, and/or various other characteristics.

In some implementations, the rider can provide information indicative of one or more object(s) to accompany the rider for the transportation service. The information can include quantity data, attribute data, and/or other data. The quantity data can indicate a number of objects to accompany the rider during the transportation service. The attribute data can indicate one or more object attributes (e.g., size, weight, visual characteristics (e.g., color, shape, etc.), etc.) for each of the number of objects. For example, the rider can request to bring a quantity and/or type of object(s) for the transportation service (e.g., to satisfy a weight limit for a transportation leg such as an aerial transportation leg, a personal item limit for the transportation leg, etc.). The computing system can obtain request data indicative of the request for the transportation service for the rider. The request data can include the quantity data, the attribute data, the origin location, the destination location, and/or any other characteristics specified by the rider for the request.

In some implementations, the multi-modal transportation service can be associated with a group of riders. For instance, the rider can be one of the group of riders (e.g., passengers, coworkers, family members, friends, etc.) associated with the multi-modal transportation itinerary for which the rider is booking the transportation service. In such a case, the request data can include information for object(s) accompanying one or more riders of the group of riders. By way of example, the quantity data can include a total number of object(s) accompanying the group of riders for the transportation service, a subset of object(s) accompanying a subset of the group of riders, etc.

A multi-modal transportation itinerary can be generated based on the request for the transportation service from the rider (e.g., and/or group of riders). The multi-modal transportation itinerary can include two or more transportation legs (e.g., a first transportation leg, a second transportation leg, a third transportation leg, etc.) between an origin and/or destination location specified in the request. The two or more transportation legs can include travel via two or more different transportation modalities such as, for example: cars, motorcycles, light electric vehicles (e.g., electric bicycles, scooters, etc.), buses, trains, aircraft (e.g., airplanes, helicopters, etc.), watercraft, walking, and/or other transportation modalities. Example aircrafts can also include helicopters and/or other vertical take-off and landing aircraft (VTOL) such as electric vertical take-off and landing aircraft (eVTOL). The vehicles can include non-autonomous, semi-autonomous, and/or fully-autonomous vehicles.

The computing system can facilitate the ability of the rider to receive transportation via one or more of the transportation legs included in the itinerary. For example, the computing system can obtain itinerary data indicative of the multi-modal transportation itinerary for facilitating the transportation for the rider. The itinerary data can identify at least a first transportation leg, a second transportation leg, and/or a third transportation leg. The itinerary data can include data associated with each transportation leg such as an origin location, destination location, an alternative modality facility (e.g., aerial facility, underground rail facility, water facility, etc.), a transportation modality, etc. The computing system can interact with the transportation platform/one or more ride-sharing networks to match the rider with one or more transportation service providers. In some implementations, the computing system can book or otherwise reserve a seat in, space on, and/or usage of one or more of the transportation modalities for the rider.

The computing system can receive object data (e.g., quantity data and attribute data) associated with the one or more objects to accompany the rider for the transportation service at any time before (e.g., initial object data) and/or during (e.g., additional object data) the multi-modal transportation itinerary. For instance, initial object data can be included in the request data accompanying the request for the transportation service from the rider. In addition, or alternatively, the initial object data can include sensor data obtained before the transportation service. The sensor data, for example, can include data gathered by one or more sensors of a first transportation vehicle assigned to provide a first transportation leg of the multi-modal transportation itinerary.

The computing system can obtain additional object data during the rider's progress through the multi-modal transportation itinerary. The additional object data can include input data and/or sensor data gathered by one or more sensors associated with one or more of the transportation modalities (e.g., ground vehicles, aerial vehicles, water-based vehicles, transportation infrastructure, etc.) assigned to perform and/or facilitate a portion of the multi-modal transportation itinerary.

As an example, a vehicle and/or a transportation infrastructure of a transportation modality (e.g., ground vehicle, aerial vehicle, water-based vehicle, transportation hub, aerial facility, water-based facility, etc.) associated with one or more of the transportation legs of the multi-modal transportation itinerary can include and/or be equipped with one or more sensors, such as a set of cameras, a set of weighing devices, a set of suspension sensors, a set of light detection and ranging (LIDAR) sensors, a set of ultrasound sensors, a set of location-determination sensors, a set of radio-frequency sensors (such as Bluetooth or Wi-Fi transceivers), and/or other sensors used for various operations of the respective vehicle or infrastructure. By way of example, a ground, aerial, and/or water-based vehicle can include engine sensors, tire pressure sensors, door position sensors, seat belt sensors, external stereo cameras or LIDAR sensors for autonomous navigation, etc. As another example, a transportation facility (e.g., aerial facility, waterside facility, underground facility, etc.) of a transportation modality (e.g., aerial-based, water-based, underground-based, etc.) can include one or more cameras (e.g., security cameras, etc.), microphones, weighing devices, magnetic imaging devices, x-ray imaging devices, etc.

The initial or additional object data can include sensor data gathered by the one or more sensors of a vehicle and/or infrastructure associated with the multi-modal transportation service at one or more times throughout a transportation service. For instance, the one or more sensors can include one or more interior and/or exterior cameras. By way of example, the one or more cameras can include one or more interior cameras (e.g., cameras positioned within a vehicle of a transportation modality, cameras positioned within a transport facility, etc.) configured to obtain interior image data (e.g., of the trunk of the vehicle, a vehicle cabin, a baggage area, etc.). In addition, or alternatively, the one or more cameras can include one or more exterior cameras (e.g., cameras positioned outside of a vehicle cabin, cameras positioned outside of the transport facility, etc.) configured to obtain exterior image data (e.g., of an area surrounding a vehicle, an area surrounding the transport facility, etc.). In these cases, the computing system can obtain object data including image data indicative of a number of object accompanying the rider (e.g., quantity data) and/or one or more attributes (e.g., attribute data) of each of the number of objects accompanying the rider. By way of example, the image data can be indicative of one or more visual attributes of the one or more objects. The visual attributes can include at least one of a shape attribute, a color attribute, and/or a size attribute.

As another example, the one or more sensors can include one or more weighing devices. The weighing device(s) can be positioned within the compartment and/or the interior of a vehicle (e.g., the trunk of the vehicle, a vehicle cabin, etc.) and/or in one or more areas of a transportation infrastructure (e.g., a baggage area of a facility, etc.). By way of example, the one or more weighing devices can be positioned within the vehicle such that the respective measuring platform of the set of weighing devices is positioned on, positioned below, or included with a bottom surface of the respective compartment and/or interior of the vehicle. In such a case, the computing system can obtain object data including weight data indicative of the number of objects accompanying the rider and/or the weight of the number of object(s) accompanying the rider.

The one or more sensors can include any other additional sensors configured to detect the quantity and/or attribute of the one or more objects accompanying the rider. For instance, the sensors can include location sensor(s) (e.g., radio frequency identification tags, global positioning devices, etc.), suspension sensor(s) (e.g., configured to provide compression information indicative of the presence of objects within a vehicle, etc.), etc. As described in greater detail below, the computing system can utilize the sensor data to determine whether object(s) are located in a vehicle, moving with a vehicle, etc. In some implementations, the described sensor data can be combined with additional sensor data (e.g., camera data, etc.) to associate the sensor data with the particular object(s).

In addition, or alternatively, the additional object data can include input data received from one or more devices associated with one or more participants (e.g., a rider device of the rider, a vehicle operator device of a vehicle operator, an infrastructure device of one or more infrastructure personnel (e.g., a greeter at a transportation facility, etc.), etc.) of the multi-modal transportation itinerary. By way of example, the multi-modal transportation itinerary can include a plurality of participants. The plurality of participants can include the rider (e.g., participating by receiving the transportation service), one or more vehicle operators (e.g., an operator of a ground vehicle, an aerial vehicle, a water-based vehicle, etc. assigned to perform at least one transportation leg of the itinerary, etc.), and/or one or more infrastructure personnel. The one or more infrastructure personnel can include one or more transportation facility personnel assigned to facilitate the transfer of the rider and/or object(s) from a ground transportation service to another transportation service. By way of example, the one or more infrastructure personnel can include a greeter assigned to direct the rider upon arrival at an aerial/water transport facility, a service desk operator assigned to check-in the rider for an aerial/water transport, etc.

Each of the plurality of participants can be associated with a respective device. By way of example, the rider can be associated with the rider device, as described above, with which the rider can communicate with the computing system. The vehicle operators can be associated with an operator device (e.g., onboard tablet, mobile phone, etc.). And, the infrastructure personnel can be associated with an infrastructure device (e.g., a greeter can be associated with a greeter device, a service desk operator can be associated with a terminal device, etc.). Each of the devices (e.g., rider device, operator devices, and/or infrastructure devices) can be configured to display one or more user interfaces. Each participant of the multi-modal transportation itinerary can interact with the one or more user interfaces to communicate with the computing system. For instance, the participants can input additional object data indicative of the number and/or attributes of one or more objects at one or more points along the multi-modal transportation itinerary. In addition, or alternatively, the computing systems can provide data indicative of the one or more objects to one or more of the devices.

The computing system can generate a user-object profile for the rider based on the initial object data and the multi-modal transportation itinerary for facilitating multi-modal transportation of the rider. For example, the user-object profile can be indicative of an association between the rider and the object(s) accompanying the rider during the multi-modal transportation itinerary. The user-object profile can include an identifier for the object(s) accompanying the rider (e.g., a unique identifier indicative of an object (e.g., an object attribute, etc.)) and/or one or more object characteristics as identified by the quantity data and/or attribute data of the initial object data. In some implementations, the user-object profile can be updated throughout the multi-modal transportation itinerary based at least in part on the progress of the rider and/or the object(s) accompanying the rider through the multi-modal transportation itinerary.

The computing system can generate the user-object profile based, at least in part, on initial object data. The initial object data can include object data initially received for the multi-modal transportation service. By way of example, the initial object data can include quantity and/or attribute data of the request data provided by the rider before the transportation service. As another example, the initial object data can include sensor data received by the computing system before the first leg of the transportation service. For instance, the initial object data can include sensor data (e.g., image data, weight data, etc.) obtained by one or more sensors associated with a vehicle assigned to perform the first transportation leg of the multi-modal transportation itinerary.

In some implementations, the computing system can perform an initial object-check action before generating the user-object profile and/or before providing the first leg of the multi-modal transportation service. The initial object-check action can include comparing the request data with the sensor data received before the first leg of the transportation service. By way of example, the request data can include first quantity data and first attribute data. The first quantity data can include a number of objects input by the rider and the first attribute data can include characteristics for each of the number of objects as specified by the rider. The sensor data can include second quantity data and second attribute data. The second quantity data can include a number of objects as detected by one or more sensors associated with the first transportation leg of the multi-modal transportation itinerary and the first attribute data can include characteristics for each of the number of objects as detected by one or more sensors associated the first transportation leg of the multi-modal transportation itinerary.

The computing system can obtain sensor data including the second quantity data and second attribute data. The second quantity data can identify a second number of objects accompanying the rider and the second attribute data can identify one or more object attributes for each object of the second number of objects. The computing system can determine the initial object-check action before the transportation service based on the request data and the sensor data. For instance, the computing system can determine whether the first quantity data and/or first attribute data corresponds to the second quantity data and/or the second attribute data.

The initial object-check action can include generating the user-object profile and/or initiating one or more preventative actions. In the event that the request data corresponds to the sensor data, the initial object-check action can include generating the user-object profile. In the event that the request data does not correspond to the sensor data, the initial object-check action can include initiating the one or more preventative actions. The one or more preventative actions can include notifying the rider, via the rider device, that the sensor data does not correspond to the request data. In addition, or alternatively, the one or more preventative actions can include providing alternative object transportation options for display (e.g., via a rider device). The alternative object transportation options can include alternative recovery methods as described herein in more detail and/or options to update the multi-modal transportation itinerary (e.g., take a later aerial transportation, pay an extra charge for an increased payload allowance, etc.).

The computing system can initiate the object-check action. For instance, the computing system can generate and/or update the user-object profile in the event that the sensor data corresponds to the request data and/or initiate one or more preventative actions in the event that the sensor data does not correspond to the request data.

In some implementations, the computing system can receive intention data in response to the one or more preventative actions (e.g., a notification that the sensor data does not correspond to the request). The intention data can indicate the rider's intention to proceed with the multi-modal transportation itinerary and/or react (e.g., retrieve an undetected bag, leave an additionally detected bag, etc.) to the one or more preventative actions. The computing system can generate/update the user-object profile based, at least in part, on the intention data. For instance, the computing system can generate a user-object profile associating the rider with the object data as indicated by the sensor data in the event that the rider's intention is to proceed with the multi-modal transportation itinerary. In addition, or alternatively, the computing system can generate the user-object profile after the rider has reacted to the one or more preventative actions (e.g., by performing another initial object-check action, etc.) in the event the rider's intention is to react to the one or more preventative actions.

The computing system can track the progress of the rider and/or the object(s) accompanying the rider through the multi-modal transportation itinerary. To do so, the computing system can track the progress of the transportation service. For example, the computing system can track the transportation service of the rider by obtaining rider location data indicative of the location of the rider and/or one or more vehicles associated with the transportation service. For example, the rider location data can be indicative of a beginning of a transportation leg (e.g., departure from an origin location, departure from a transportation facility, etc.), a completion of a transportation leg (e.g., arrival at a transportation facility, arrival at a destination location, etc.), and/or a transition between two transportation legs (e.g., checking-in operation, etc.). In some implementations, the progress of the rider can correspond to the progress of the transportation service. For instance, the progress of the rider and/or the progress of the transportation service can be the same.

The progress of the transportation service (and/or the rider) can be tracked through various location sensors (e.g., global positioning sensors, inertial measurement sensors, etc.) of one or more devices (e.g., the rider device, vehicle devices, vehicle operator device, etc.) associated with the multi-modal transportation itinerary. By way of example, the one or more devices can include one or more vehicle devices (e.g., a vehicle operator device, a vehicle computing system, etc.) associated with one or more vehicles assigned to perform at least a portion of the multi-modal transportation itinerary, a rider device associated with the rider (e.g., a rider of the transportation service), one or more infrastructure devices associated with one or more transportation infrastructures through which the transportation service progresses, etc. The one or more infrastructure devices, for example, can include one or more greeter devices associated with a greater at a transportation facility and/or one or more terminal devices associated with a check-in operation at the transportation facility.

In some implementations, the progress of the transportation service (and/or the rider) can be tracked through user input (e.g., notifying that the transportation leg has been completed) to one or more of the devices associated with the transportation service. The input, for example, can be provided by a vehicle operator (e.g., a driver, pilot, captain, conductor, remote operator, etc.) to a vehicle device, by the rider to a rider device, and/or by personnel (e.g., greeter, service desk operator, etc.) at a transportation facility to an infrastructure device (e.g., greeter device, terminal device, etc.), etc.

The progress of the transportation service can be indicative of the location of a vehicle and/or the rider along the multi-modal transportation service. In this manner, the computing system can identify a completion of a (first, second, third, etc.) transportation leg of the multi-modal transportation itinerary. For instance, the computing system can detect the arrival of a first vehicle (e.g., assigned to perform the first transportation leg of the multi-modal transportation itinerary) at an origin location of the rider and/or a transportation facility; the arrival of a second vehicle (e.g., assigned to perform the second transportation leg of the multi-modal transportation itinerary) at the first and/or second transportation facilities; the arrival of a third vehicle (e.g., assigned to perform the third transportation leg of the multi-modal transportation itinerary) at the second transportation facility and/or a destination location of the rider; etc.

Upon identifying a completion of a (e.g., first, second, third, etc.) transportation leg of the multi-modal transportation itinerary, the computing system can determine an object-check action. The object-check action can be determined by comparing the progress of the rider and the one or more object(s) accompanying the rider along the transportation service. By way of example, the progress of the rider along the transportation service can include the progress of the transportation service, whereas the progress of the object(s) accompanying the rider can include the progress of the transportation service and/or an indication that the object(s)'s progress is behind the progress of the transportation service (e.g., the object(s) are still associated with a previous transportation leg occurring before the current transportation leg of the rider and/or transportation service).

The computing system can determine an object-check action by obtaining additional object data associated with the object(s). The additional object data can be obtained after the completion of a respective transportation leg and/or during the transition between respective transportation legs of the multi-modal transportation itinerary. The additional object data can include sensor data obtained from various sensors (e.g., camera, payload, suspension, etc.) associated with a vehicle and/or infrastructure associated with the respective legs. For instance, the additional object data can include the sensor data, described herein, obtained after the generation of the user-object profile. The sensor data can include data indicative of one or more object characteristics (e.g., visual (e.g., size, shape, color, etc.), weight, etc.) associated with one or more of the object(s) at a location relative to the multi-modal transportation itinerary (e.g., in a vehicle of a respective leg of the transportation service, along the route of the transportation service, etc.). In addition, or alternatively, the additional object data can include input data (e.g., notifying that the object(s) are cleared from the vehicle or remain in the vehicle) provided by an operator, rider, and/or other personnel associated with the respective legs of the multi-modal transportation itinerary.

The computing system can determine object location data indicative of a relative location of at least one of the one or more objects to the rider based, at least in part, on the additional object data, the user-object profile, and/or at least one transportation leg. For example, the computing system can identify the completion of at least one transportation leg of the multi-modal transportation itinerary. The computing system can determine a rider location based, at least in part, on the at least one transportation leg. The object location data can identify a location of an object relative to the rider location.

The computing system can determine the object location data by comparing the additional object data to the user-object profile. For example, the computing system can identify one or more objects associated with a rider at a location along the multi-modal transportation itinerary by comparing one or more object characteristics (e.g., quantity data, attribute data, etc.) of the additional object data to the object characteristics of the user-object profile.

As an example, the additional object data can be indicative of the presence of an object (e.g., as identified by input data, sensor data, etc.) within a vehicle or infrastructure associated with a transportation leg of the multi-modal transportation itinerary. For instance, the additional object data can include input data from one or more participants of the at least one transportation leg and can be provided after the one or more participants manually check for the presence of the object(s) along the multi-modal transportation itinerary. By way of example, the additional object data can include input data from a vehicle operator indicating that one or more of the object(s) are/are not present within a vehicle associated with the vehicle operator. The computing system can determine the object location data for each of the object(s) accompanying the rider along the multi-modal transportation service by comparing the input data to the user-object profile (e.g., if the one or more objects are not present, are transitioning to another transportation leg with the rider, etc.).

As another example, the additional object data can include sensor data from one or more sensors associated with a portion of the multi-modal transportation itinerary. The computing system can determine an object's location along the multi-modal transportation service by comparing one or more attributes (e.g., visual characteristics, weight, etc.) of the additional object data to the user-object profile. For example, the computing system can compare one or more attributes (e.g., visual characteristics, weight, etc.) of the additional object data to the user-object profile to identify one or more object(s) of the user-object profile along the portion of the multi-modal transportation itinerary.

The computing system can compare an object's location along the multi-modal transportation itinerary (e.g., as identified by the object location data) to the rider location to determine the object location data. The object location data can indicate whether the object(s) to accompany the rider during the multi-modal transportation itinerary (e.g., as identified by the user-object profile) are within or outside an acceptable relative location range. For example, the object location data can be indicative of the locational relationship between the object(s) and/or the rider. It can include an indication of whether the object(s) remain with the rider and/or have been separated from the rider. For instance, the relative location can include a distance between the rider and/or the object(s), a respective transportation leg associated with the rider and/or one or more object(s), etc. An acceptable relative location range can be a distance and/or a progress along the transportation itinerary. For instance, the acceptable relative location range can include an expected maximum distance (e.g., distance between a rider and/or a baggage area of a vehicle, transportation infrastructure, etc.) between the rider and/or the one or more object(s) accompanying the rider. In addition, or alternatively, the acceptable relative location range can include the current transportation leg associated with the rider. For instance, the acceptable relative location range can be indicative of the progress of the rider along the multi-modal transportation itinerary.

The computing system can identify the presence of the object(s) with the rider and/or a separation of the object(s) from the rider based on the object location data and the acceptable relative location range. For instance, the computing system can determine that the object(s) are with a rider if the object location data is indicative of a relative location within the acceptable relative location range. In addition, or alternatively, the computing system can determine that the object(s) are separated from the rider if the object location data is indicative of a relative location outside of the acceptable relative location range.

As an example, the object location data can indicate the presence of an object within a vehicle assigned to perform a first transportation leg of the multi-modal transportation itinerary and that the rider location is between the first transportation leg and the second transportation leg (e.g., during a transportation leg transfer). The acceptable relative location range can indicate the portion of the multi-modal transportation itinerary between the first transportation leg and the second transportation leg (e.g., the progress of the rider). In such a case, the object location data can indicate that the object is separated from the rider because the location of the object is outside of the acceptable relative location range.

The computing system can determine an object-check action based at least in part on the multi-modal transportation itinerary (e.g., a respective leg of the multi-modal transportation itinerary), the user-object profile, and/or the object location data. For instance, the object-check action can be based on the progress of the rider and/or the progress of the object(s) accompanying the rider. An object-check action can include one or more actions to further the multi-modal transportation itinerary, one or more actions to block one or more aspects of the transportation service, and/or one or more actions to recover one or more separated object(s). For instance, the object-check action can include providing a notification to a device (e.g., a rider device associated with the rider, vehicle device associated with a vehicle, infrastructure device associated with a transportation facility, etc.), blocking an action of a vehicle, rider, operator, or personnel associated with the transportation service, facilitating the progress of the rider through the multi-modal transportation itinerary, and/or facilitating the recovery of one or more separated objects. The object-check action can be determined based, at least in part, on a comparison between the progress of the rider and/or the progress of the object(s) accompanying the rider (e.g., the object location data).

For example, the computing system can facilitate the multi-modal transportation itinerary in the event that the object location data is indicative of the object(s)'s relative location within the acceptable relative location range (e.g., within a threshold distance, matching the rider's progress, etc.). For example, if the object location data is indicative of an object's relative location that is within the acceptable relative location range, the object-check action can include providing for display a portion of the itinerary data indicative of a transportation leg subsequent to the current transportation leg of the multi-modal transportation itinerary. For instance, if the rider has all of the object(s) identified by the user-object profile, the computing system can display itinerary information that was not already available to the rider (e.g., aircraft number, seat assignment, vehicle identifier, driver name, etc.).

The computing system can perform one or more blockings actions and/or recovery actions in the event that the object location data is indicative of an object's relative location outside of the acceptable relative location range (e.g., outside the threshold distance, not matching the rider's progress, etc.). For example, if the object location data is indicative of an object's relative location that is outside an acceptable relative location range (e.g., outside a threshold distance, associated with a transportation leg preceding the current transportation leg of the rider and/or multi-modal transportation itinerary, and/or the rider's progress and/or the object's progress not otherwise matching, etc.), the object-check action can include preventing the progression of the multi-modal transportation for the rider (e.g., prevent display of further details about a subsequent transportation leg, etc.) and/or preventing a vehicle associated with the preceding transportation leg (ground vehicle, aerial vehicle, water vehicle, etc.) from ending the current transportation service and/or starting a new transportation service.

By way of example, the object-check action can include preventing a vehicle operator from ending a service assignment and/or beginning a new service assignment until a rider (and/or infrastructure personnel (e.g., a greeter and/or other personnel, etc.)) has acknowledged that an object has been separated from the rider. In some implementations, the rider can immediately retrieve the object(s). The computing system can obtain additional object data indicative of the retrieval. In response, the computing system can enable (e.g., allow the termination of the service assignment and/or the acceptance of a new service assignment) the vehicle, vehicle operator, other personnel to end the current transportation service and/or accept another transportation service (e.g., to transport another rider).

As another example, the object-check action can include one or more object recovery actions. The one or more object recovery actions can include providing a notification to one or more transportation leg participants (e.g., the rider, a vehicle operator, a greeter at a transportation facility, etc.) and/or obtaining response data indicative of an acknowledgment of whether the relative location of the object(s) are within or outside an acceptable relative location range (e.g., with the rider, separated from the rider, etc.). In some implementations, the object-check action can prevent a vehicle from ending the current trip and/or starting a new trip until an acknowledgement (e.g., a notification that the passenger has obtained the object(s) or that the rider has chosen to continue the trip and/or choose an alternative recovery method, etc.) is received from the rider associated with the separated object.

For instance, the computing system can provide data indicative of the relative location(s) of the object(s) to one or more devices associated with one or more participants of the transportation leg. The one or more participants of the transportation leg, for example, can include the rider, a vehicle operator, and/or personnel associated with a transportation facility. In some implementations, the data can include a message indicating that the relative location of an object is outside of the acceptable relative location range. For example, the data can be a notification that the rider has been separated from the object(s).

The computing system can obtain response data indicative of a response to the message. For example, the response data can be obtained via input to any device (e.g., operator device, rider device, infrastructure device (e.g., a greeter device, etc.), etc.) associated with a participant of the at least one transportation leg associated with the object-check action. By way of example, the user input can include an acknowledgement by a participant (e.g., rider, operator, personnel, etc.) of the notification.

In some implementations, acknowledging that the object(s) have been separated can include a selection of a recovery option for an object that has been separated from the rider. For instance, the computing system can generate recovery data including one or more alternative object transportation options. The recovery data can include cost prediction(s) and/or time prediction(s) associated with each of the one or more alternative object transportation options. The computing system can provide the recovery data to the rider device for display by the user interface of the rider device.

The alternative object transportation options can include delivery of the object(s) to the rider's destination location, delivery of the object(s) to a third location obtained from the rider (e.g., through user input of an address (e.g., to a hotel, a rider's home, etc.)), and/or obtaining the object(s) from a recovery facility (e.g., a customer service center, aerial facility, water facility, etc.). The computing system can obtain a rider response indicative of the rider's choice of an alternative recovery option for the separated object. The computing system can generate an alternative object itinerary based on the multi-modal transportation itinerary of the rider and/or the one or more alternative object transportation options for the separated object. The computing system can provide data indicative of the alternative object itinerary to the rider device for display via the user interface.

In some implementations, the computing system can determine an object-check action based on a prior object-check action. For instance, the rider response data received in response to a prior object-check action can be indicative of the rider proceeding with the transportation itinerary without the separated object(s) and/or selection of one or more alternative transportation options for the separated object(s). In such a case, the object-check action can include updating the user-object profile to include data indicative of the rider response data. Additionally, or alternatively, the object-check action can include providing a notification for display via a rider device and/or obtaining a rider response to the notification.

The computing system can obtain additional object data and determine and/or initiate one or more object-check action(s) at one or more times as the rider progresses through the multi-modal transportation itinerary. As an example, the computing system can obtain additional object data, and determine and/or initiate one or more object-check action(s) before, after, during, and/or between each transportation leg of the multi-modal transportation itinerary.

By way of example, the computing system can determine a first object-check action after a first transportation leg. To do so, the computing system can obtain additional object data after the first transportation leg of the multi-modal transportation itinerary. For example, the first transportation leg can be a ground transportation leg from an origin location to a first transportation facility. The additional object data can include input data from a vehicle operator assigned to perform the first transportation leg and/or a greeter assigned to direct the rider to the second transportation leg of the multi-modal transportation itinerary. In addition, or alternatively, the additional object data can include sensor data obtained via one or more sensors associated with the first transportation leg. The one or more sensors can include one or more vehicle sensors of the ground vehicle assigned to perform the first transportation leg and/or one or more facility sensors of the first transportation facility.

The object-check action can include providing data indicative of the relative location of an object to one or more computing devices associated with one or more participants of the first transportation leg. The one or more participants can include the rider, the operator of the ground vehicle assigned to perform the first transportation leg, and/or transportation facility personnel associated with the transportation facility. By way of example, the object-check action can include providing a notification to one or more of the participants (e.g., a message that object(s) are separated from the rider, etc.), obtaining a response from one or more of the participants (e.g., the rider choosing an alternate recovery option), and/or performing a blocking action such as preventing details of a subsequent transportation leg to the current transportation leg from displaying at the rider device, preventing the vehicle operator from accepting another transportation service assignment, etc. The computing system can initiate the object-check action to prevent the separation and/or enable the recovery of the one or more objects intended to accompany the rider during the multi-modal transportation service.

As another example, an object-check action can be initiated between a ground transportation leg and another transportation leg via a different transportation medium (e.g., air-based, underground-based, water-based, etc.) and/or modality (e.g., manually driven motor vehicles, autonomously driven motor vehicles, light electric vehicles, electric vertical take-off and landing aircraft, airplanes, drones, cruise ships, ferries, etc.). For example, the computing system can identify a checking-in operation associated with the rider. The checking-in operation can include a process by which the rider checks into (e.g., confirms the rider's arrival, etc.) the other transportation leg of the multi-modal transportation itinerary. For instance, the checking-in operation can be performed at an aerial facility associated with an aerial transportation leg of the multi-modal transportation itinerary. The computing system can determine a second object-check action in response to identifying the checking-in operation associated with the rider.

The computing system can determine the second object-check action based, at least in part, on object-check actions preceding the second object-check action. For example, the computing system can obtain data indicative of a first object-check action determined based, at least in part, on the first transportation leg, the user-object profile, and first leg object location data indicative of a relative location of an object to a rider after the first transportation leg. The computing system can determine a second object-check action based, at least in part, on the first object-check action and the checking-in operation associated with the rider.

For example, the computing system can determine that the relative location of the object after the first transportation leg was outside of an acceptable relative location range based, at least in part, on the first object-check action. For instance, the first object-check action can include providing data indicative of a separated object to the rider device. In response, the computing system can determine that the relative location of the object after the first transportation leg was outside of the acceptable relative location range.

The computing system can determine the second object-check action based, at least in part, on whether the first object-check action was addressed. For example, the computing system can obtain additional object data and determine object location data for the one or more objects identified by the user-object profile during the checking-in operation. The computing system can determine that the first object-check action was not addressed in the event that an object currently outside of the acceptable relative location range. In addition, or alternatively, the computing system can determine that the first object-check action was addressed in the event that the object is currently within the acceptable relative location range.

In the event that the first object-check action was not addressed, the computing system can provide data indicative of the relative location of the object to at least one device associated with the checking-in operation. For example, the checking-in operation can include a self-checking operation (e.g., via the rider device) and/or a checking-in operation via one or more facility devices (e.g., a terminal device, a greeter device, etc.). The computing system can determine which device is being used to check-in and provide data indicative of the relative location of the object to that device.

By way of example, if there are separated object(s), the computing system can cause a message directing the rider to retrieve the separated object(s) to display on the device associated with the checking-in operation (e.g., a terminal device, a rider device, etc.). If the rider chooses not to retrieve the object(s) immediately, the rider can be presented with alternative transportation options for the object(s). In a similar manner, a notification about the separated object(s) can be provided for display to transportation facility personnel (e.g., greeter, service desk operator, etc.) via an infrastructure device (e.g., greeter device, terminal device, etc.). The computing system can update the rider's multi-modal transportation itinerary based in part on the rider response to the first and/or second object-check action. For instance, if a rider chooses to immediately retrieve object(s) from a prior transportation leg, the computing system can determine if the next transportation leg should be delayed to accommodate the rider and/or if the rider's itinerary should be updated (e.g., for a later flight, etc.).

In some implementations, the object-check action can be indicative of the object(s) remaining with the rider. In this example, the computing system can provide for the display of information about transportation legs of a different medium/modality (e.g., identity of the rider, weight, boarding time, the door to leave out of, etc.). Further, the computing system can obtain a rider response confirming the information about the trip.

As another example, the object-check action can be determined and/or initiated after the performance of the transportation leg of a different medium/modality. The object-check action can include notifying the rider and/or transportation facility personnel (e.g., ramp staff, etc.) at a destination transportation facility that an object has been separated from the rider (e.g., the object(s) remain on the vehicle of the transportation leg, etc.). For example, the notification to the rider can include a message to the rider to not return to the vehicle to retrieve the luggage (e.g., notifying the rider to instead retrieve the object(s) from transportation facility personnel, etc.). Initiating the object-check action can further include preventing the display of information about a subsequent transportation leg (e.g., driver name, vehicle identifier, etc.) until the rider has retrieved the separated object(s) from the personnel associated with the transportation facility or chosen an alternative recovery method for the object(s). Additionally, or alternatively, the object-check action can include preventing a vehicle from commencing a subsequent passenger loading process until all object(s) have been cleared out of the vehicle by riders or personnel associated with the second transportation facility (e.g., ramp staff, etc.).

In addition, or alternatively, the computing system can determine a concluding object-check action after the completion of the multi-modal transportation itinerary. To do so, the computing system can obtain object location data associated with one or more of the first transportation legs, the second transportation leg, and/or the third transportation leg of the multi-modal transportation itinerary. For example, the object location data can include a relative location of at least one object of the one or more objects identified by the user-object profile to the rider after and/or during a transition between each of the transportation legs of the multi-modal transportation itinerary.

The computing system can determine whether the at least one object was separated from the rider during the multi-modal transportation service based, at least in part, on the object location data. For example, the computing system can determine that the object is a separated object that has been separated from the rider during the transportation service based, at least in part, on the object location data. As an example, the relative location of the object can include a relative location outside of an acceptable relative location range at one or more points during the multi-modal transportation service. In the event that the object is not retrieved (e.g., the object is outside the acceptable relative location range after the final transportation leg of the multi-modal transportation itinerary, etc.) the computing system can determine that the object is a separated object.

The computing system can obtain recovery data including one or more alternative object transportation options for the separated object. The computing system can receive a selection of an alternative object transportation option (e.g., at the time the rider is separated from the object, at the end of the multi-modal transportation service, etc.). The computing system can generate an object itinerary for the separated object based, at least in part, on the itinerary data and/or the recovery data (and/or the selected alternative object transportation option). For instance, the object itinerary can include a transportation itinerary from the point at which the object is separated from the rider to a destination (e.g., a destination of the multi-modal transportation itinerary, an alternative rider provided destination, etc.) associated with the rider. The concluding object-check action can include providing the object itinerary to the rider device for display via the user interface.

By way of example, the computing system can detect the completion of the transportation service (e.g., arrival at the destination, etc.). Upon detecting the completion of the transportation service, the computing system can determine the concluding object-check action by determining that an alternative object itinerary has been created (e.g., during a previous object-check action). The computing system can determine that the rider chose an alternative recovery method for the object(s) separated from the rider during one or more of the previous transportation leg(s) of the multi-modal transportation itinerary. The computing system can further determine the current status of the alternative recovery method based at least in part on additional object location data and/or the object itinerary. The current status of the separated object can include a current object location, an estimated time for delivery, and/or an estimated time for return of the separated object to the rider. The computing system can provide the current status of the object(s) for display via the rider device.

Example aspects of the present disclosure can provide a number of improvements to transportation service computing technology such as, for example, multi-modal transportation and/or object tracking technology. For instance, the systems and methods of the present disclosure provide an improved approach for facilitating a multi-modal transportation service for a rider and/or one or more accompanying objects. For example, a computing system can obtain itinerary data for facilitating a multi-modal transportation service for a rider. The computing system can obtain object data indicative of one or more objects accompanying the rider during the transportation service and generate a user-object profile indicative of an association between the object data and the rider. The computing system can obtain object location data and determine and initiate an object-check action at one points during the transportation service. In this manner, the present disclosure presents an improved computing system that can effectively monitor the progress of one or more objects accompanying a rider during a transportation service. The computing system can accumulate and utilize newly available information such as, for example, object location data and user-object profiles and track the progress of riders and/or objects accompanying those riders throughout a multi-modal transportation service. In this way, the computing system provides a practical application that prevents a rider from being separated from one or more belongings during a transportation service. The computer-implemented techniques disclosed herein result in seamless object tracking and/or rider notification within a transportation service. This can provide a more efficient approach to facilitating transportation services in general, and, specifically, for facilitating transportation services for a rider with one or more accompanying objects, thereby saving processing and/or memory resources devoted to the recovery of objects separated during the course of transportation services.

Additionally, the technology of the present disclosure can improve efficiency of the computing resources underlying the transportation platform. For example, the computing system, as described, can utilize a rider's itinerary as a basis for generating alternative object recovery options for an object that is separated from the rider during the transportation service. This can allow the computing system to avoid utilizing additional processing and/or memory resources on processing customer service requests pertaining to forgotten objects. Ultimately, this can allow the computing systems to instead utilize these additional computational resources on improved monitoring, more efficient contingencies planning, better itinerary adjustment, etc.

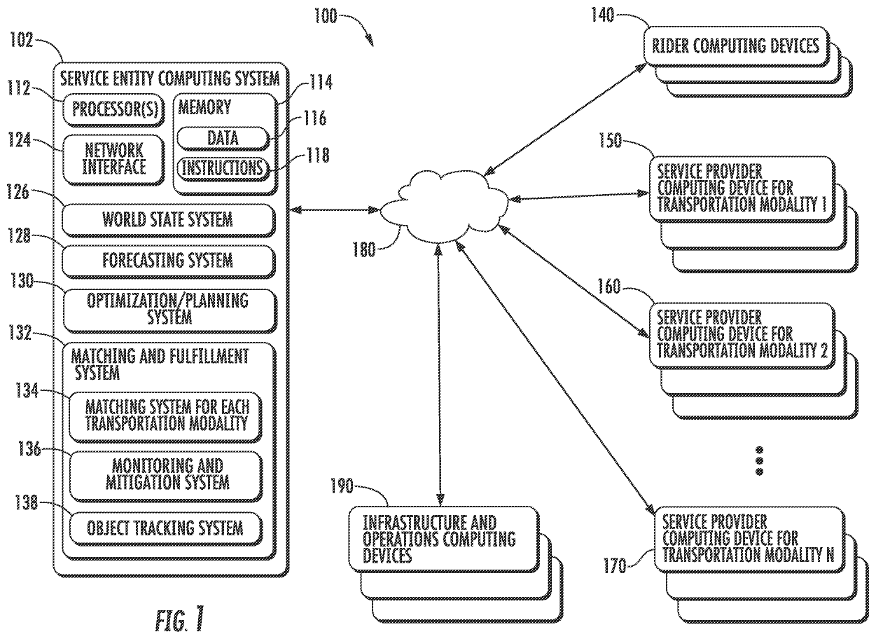

With reference now to FIGS. 1-12, example embodiments of the present disclosure will be discussed in further detail. FIG. 1 depicts a block diagram of an example system 100 according to example embodiments of the present disclosure. The system 100 can include a service entity computing system 102 that can operate to control, route, monitor, and/or communicate with vehicles such as ground vehicles, aircraft (e.g., VTOL aircraft), etc. and/or one or more other transportation service entities (e.g., third-party vehicle providers) to facilitate a multi-modal transportation service. These operations can be performed as part of a multi-modal transportation service for passengers, for example, including travel by ground vehicle and travel by alternative modalities such as aircraft (e.g., VTOL aircraft, etc.), watercraft (e.g., ferries, etc.), subway trains, etc.

The service entity computing system 102 can be communicatively connected over a network 180 to one or more rider computing devices 140, one or more service provider computing devices 150 for a first transportation modality, one or more service provider computing devices 160 for a second transportation modality, one or more service provider computing devices 170 for an Nth transportation modality, and/or one or more infrastructure and operations computing devices 190.

Each of the computing devices 140, 150, 160, 170, 190 can include any type of computing device such as a smartphone, tablet, hand-held computing device, wearable computing device, embedded computing device, navigational computing device, vehicle computing device, etc. A computing device can include one or more processors and a memory (e.g., similar to as will be discussed with reference to processors 112 and memory 114). Although service provider computing devices are shown for N different transportation modalities, any number of different transportation modalities can be used, including, for example, less than the three illustrated modalities (e.g., two modalities can be used).

More particularly, the service provider computing devices 150, 160, 170 can be associated with a vehicle (and/or an intermediary computing system) of a respective transportation modality. For example, the service provider computing devices 150, 160, 170 can include a vehicle computing device, a system of an autonomous, semi-autonomous, or non-autonomous vehicle, or an intermediary computing system for a public transportation service. As another example, the service provider computing devices 150, 160, 170 can include an operator device associated with an operator (e.g., driver, pilot, remote operator, captain, conductor, etc.) of a vehicle. The infrastructure and operations computing devices 190 can be any form of computing device used by operations personnel and/or located at a transportation facility such as, for example, an aerial transport facility, a water transport facility, a rail transport facility, etc. The infrastructure and operations computing devices 190 can include, for example, devices configured to perform passenger security checks (e.g., a terminal devices), luggage check in/out, recharging/re-fueling, vehicle check in/out, and/or the like. By way of example, the infrastructure and operations computing devices 190 can include one or more greeter devices associated with a greeter (e.g., operations personnel for directing a rider to the next leg of an itinerary) and/or one or more terminal devices associated with a check-in operation (e.g., to check a rider into the next leg of an itinerary).

Each of the computing devices 140, 150, 160, 170, 190 can include and/or have access to one or more sensors configured to gather sensor data. For example, a vehicle and/or a transportation infrastructure of a transportation modality (e.g., ground vehicle, aerial vehicle, transportation hub, aerial facility, waterside facility, etc.) associated with one or more of the transportation legs of a multi-modal transportation itinerary can include and/or be equipped with one or more sensors, such as a set of cameras, a set of weighing devices, a set of suspension sensors, a set of light detection and ranging (LIDAR) sensors, a set of ultrasound sensors, a set of location-determination sensors, a set of radio-frequency sensors (such as Bluetooth or Wi-Fi transceivers), and/or other sensors used for various operations of the respective vehicle or infrastructure. By way of example, a ground, aerial, water, etc. vehicle can include engine sensors, tire pressure sensors, door position sensors, seat belt sensors, external stereo cameras or LIDAR sensors for autonomous navigation, etc. As another example, an aerial facility of an aerial transportation modality, a waterside facility of a water transportation modality, or any other facility of an alternative transportation modality can include one or more cameras (e.g., security cameras, etc.), microphones, weighing devices, magnetic imaging devices, x-ray imaging devices, etc. In addition, devices such as a driver device, pilot device, captain device, conductor device, rider device 140, infrastructure and operations computing device(s) 190 (e.g., greeter device, terminal device, etc.), etc. can include one or more cameras, microphones, etc. configured to captured sensor data.

More particularly, the one or more sensor(s) can include one or more interior cameras, exterior cameras, and/or mobile cameras. By way of example, the one or more cameras can include one or more interior cameras such as, for example, interior vehicle cameras positioned within a vehicle of a transportation modality, interior facility cameras positioned within a transportation facility (e.g., aerial transport facility, waterside transport facility, etc.), etc. The interior cameras can be configured to obtain interior image data (e.g., of the trunk of the vehicle, a vehicle cabin, a baggage area, etc.). In addition, or alternatively, the one or more cameras can include one or more exterior cameras such as, for example, exterior vehicle cameras positioned outside of a vehicle cabin, exterior facility cameras positioned outside of the transportation facility (e.g., security camera, etc.), etc. The exterior cameras can be configured to obtain exterior image data (e.g., of an area surrounding a vehicle, an area surrounding the aerial transport facility, etc.). As another example, the one or more cameras can include one or more mobile cameras such as a camera of a rider device 140, a vehicle operator device (e.g., driver device, pilot device, captain device, conductor device, etc.), and/or a greeter or terminal personnel device.

As another example, the one or more sensors can include one or more weighing devices. The weighing device(s) can be positioned within the compartment and/or the interior of a vehicle (e.g., the trunk of the vehicle, a vehicle cabin, etc.) and/or in one or more areas of a transportation infrastructure (e.g., a baggage area of an aerial transport facility, etc.). By way of example, the one or more weighing devices can be positioned within the vehicle such that the respective measuring platform of the set of weighing devices is positioned on, positioned below, or included with a bottom surface of the respective compartment and/or interior of the vehicle.

The service entity computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage media, such as RAM, ROM, EEPROM, EPROM, one or more memory devices, flash memory devices, etc., and combinations thereof.

The memory 114 can store information that can be accessed by the one or more processors 112. For instance, the memory 114 (e.g., one or more non-transitory computer-readable storage mediums, memory devices) can store data 116 that can be obtained, received, accessed, written, manipulated, created, and/or stored. In some implementations, the service entity computing system 102 can obtain data from one or more memory device(s) that are remote from the system 102.

The memory 114 can also store computer-readable instructions 118 that can be executed by the one or more processors 112. The instructions 118 can be software written in any suitable programming language or can be implemented in hardware. Additionally, or alternatively, the instructions 118 can be executed in logically and/or virtually separate threads on processor(s) 112. For example, the memory 114 can store instructions 118 that when executed by the one or more processors 112 cause the one or more processors 112 to perform any of the operations and/or functions described herein.

In some implementations, the service entity computing system 102 can facilitate the ability of a rider (e.g., via a rider device 140) to receive transportation on one or more of the transportation legs included in an itinerary. As one example, the service entity computing system 102 can interact with one or more ride-sharing networks to match the rider with one or more transportation service providers 150, 160, 170. As another example, the service entity computing system 102 can book or otherwise reserve a seat in, space on, or usage of one or more of the transportation modalities for the rider. Additionally, or alternatively, the service entity computing system 102 can simply provide information for options to be provided by one or more third parties for one or more of the transportation legs.

More particularly, the service entity computing system 102 can be associated with a service entity and be configured to manage, coordinate, and dynamically adjust a multi-modal transportation service via a transportation platform of the service entity. The multi-modal transportation service can include a plurality of transportation legs, one of which (e.g., a second transportation leg) can include a transport of a rider by a transportation modality alternative to a ground transport. The alternative transport, for instance, can include an aerial transport, a water transport, an underground rail transport, etc. For example, the service entity computing system 102 can obtain a request for a transportation service. The request for the transportation service can include at least a request for an alternative transport (e.g., aerial, water, etc.) of a rider of a transportation platform. The operations computing system can obtain the request from a rider computing device 140 associated with the rider of the transportation platform. The rider computing device 140, for example, can include any type of computing device such as a smartphone, tablet, hand-held computing device, wearable computing device, embedded computing device, navigational computing device, etc. The rider computing device 140 can include one or more communication interfaces configured to communicate via network 180 (e.g., via one or more networks such as local area networks, wide area networks, the Internet, secure networks, cellular networks, mesh networks, etc.) with the transportation platform (e.g., service entity computing system 102).

A transportation platform, for example, can include cloud services system communicatively connected over a network to a plurality of riders (e.g., via one or more rider devices 140, etc.), a plurality service providers (e.g., via one or more service provider devices 150, 160, 170, etc.), etc. The transportation platform can be configured to leverage transportation capabilities of the plurality of service providers to schedule and facilitate a multi-modal transportation service for the plurality of riders (and/or one or more objects to accompany the riders). The service entity computing system 102 can be configured to coordinate multi-modal transportation for the transportation platform.

In some implementations, the rider computing device 140 can generate the request. For instance, the rider computing device 140 can include a software application running on the rider computing device 140. The software application, for example, can be associated with the rider and/or the transportation platform. For example, the rider can be associated with an account on the transportation platform and the software application can allow the rider to book a multi-model transportation service of the service entity using the rider's account (e.g., enter object details, to facilitate payment, maintain usage history, apply discounts, identify preferences, etc.). The rider can interact with the software application running on the rider computing device 140 (e.g., via a user interface) to generate the request for the transportation service.

The request can include a request for a transportation service for the rider (and/or one or more object(s) to accompany the rider) from an origin location to a destination location. By way of example, the rider can interact with the software application running on the rider computing device 140 to initiate the request. In some instances, unless specified otherwise, the origin of the transportation service can be assumed to be a current location of the rider (e.g., as indicated by location data such as global positioning system (GPS) data received from the rider device and/or as input by the rider). The rider can also supply a desired destination (e.g., by typing the destination into a text field which may, for example, provide suggested completed entries while the rider types).

In some implementations, the rider can also supply an “arrive by” date and/or time at which the rider desires to arrive at the requested destination. Thus, the rider can specify when the rider would like to arrive at the destination. In other implementations, the request can indicate a “depart at” date and/or time that the rider would like to depart. In some examples, the “depart at” date and/or time can be assumed to be the current date and/or time unless specified otherwise. The rider can also provide entries for any number of additional characteristics that the rider would like the transportation service to meet. For example, additional entries can specify a required number of seats, a preferred vehicle type (e.g., luxury vs. economy, humanly-operated vs. autonomous, etc.), an estimated payload weight (e.g., passengers and/or object weight, etc.), a preferred payload capacity (e.g., so that the vehicle accommodates the weight of any objects accompanying the rider, etc.), maximum price, and/or various other characteristics.

For example, the rider can provide information indicative of one or more object(s) to accompany the rider for the transportation service. The information can include quantity data, attribute data, and/or other data. The quantity data can indicate a number of objects to accompany the rider during the transportation service. The attribute data can indicate one or more object attributes (e.g., size, weight, visual characteristics (e.g., color, shape, etc.), etc.) for each of the number of objects. For example, the rider can request to bring a quantity and/or type of object(s) for the transportation service (e.g., to satisfy a weight limit for an aerial transportation leg, a personal item limit for an aerial transportation leg, etc.). The service entity computing system 102 can obtain request data indicative of the request for the transportation service for the rider. The request data can include the quantity data, the attribute data, the origin location, the destination location, and/or any other characteristics specified by the rider for the request.

In some implementations, the request can include a request for transportation for a group of rider. For instance, requested transportation service can be associated with a group of riders. For example, the rider can be one of the group of riders (e.g., passengers, coworkers, family members, friends, etc.) associated with the multi-modal transportation itinerary for which the rider is booking the transportation service. In such a case, the request data can include information for object(s) accompanying one or more riders of the group of riders. By way of example, the quantity data can include a total number of object(s) accompanying the group of riders for the transportation service, a subset of object(s) accompanying a subset of the group of riders, etc.

In response to the request, the service entity computing system 102 can generate at least one itinerary that includes transportation of the rider from the origin to the destination. Specifically, the service entity computing system 102 can create an end-to-end multi-modal itinerary that includes two or more transportation legs that include travel via two or more different transportation modalities such as, for example: cars, light electric vehicles (e.g., electric bicycles or scooters), buses, trains, aircraft, watercraft, and/or other transportation modalities. Example aircrafts can include helicopters and other vertical take-off and landing aircraft (VTOL) such as electric vertical take-off and landing aircraft (eVTOL). The vehicles can include non-autonomous, semi-autonomous, and/or fully-autonomous vehicles provided and/or maintained by one or more service providers (e.g., service providers associated with service provider computing device(s) 150, 160, 170).

The service entity computing system 102 can perform one or more algorithms to generate an itinerary for the rider. As an example, the service entity computing system 102 can sequentially analyze and identify potential transportation legs for each different available transportation modality. For example, a most critical, challenging, and/or supply-constrained transportation leg can be identified first and then the remainder of the itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first).

As one particular example, in some implementations, the service entity computing system 102 can initially analyze a first transportation modality that is the most efficient (e.g., in terms of travel speed and/or cost) transportation modality which operates according to a fixed infrastructure. As an example, for most longer transportation services and for the mix of different modalities described above, flight modalities will often both be the most efficient transportation modality (e.g., in terms travel speed/time) while also operating according to a fixed infrastructure. By first analyzing the most efficient transportation modality which operates according to a fixed infrastructure, the service entity computing system 102 can seek to identify an important transportation leg around which the remainder of the itinerary can be stitched.

More particularly, in some implementations, one or more of the transportation modalities can operate according to or within a fixed transportation infrastructure in which the ability of passengers to embark and disembark vehicles is constrained to a defined set of transportation nodes. For instance, the fixed transportation infrastructure can include a plurality of aerial vehicles (e.g., service entity aircraft, third-party aircraft, etc.) that operate within a ride sharing network facilitated by the service entity computing system 102. The aerial vehicle(s) can be constrained to load and unload passengers only at a defined set of physical take-off and/or landing areas which may in some instances be referred to as transportation facilities such as aerial transport facilities, waterside facilities, underground facilities, and/or alternative transport facilities.

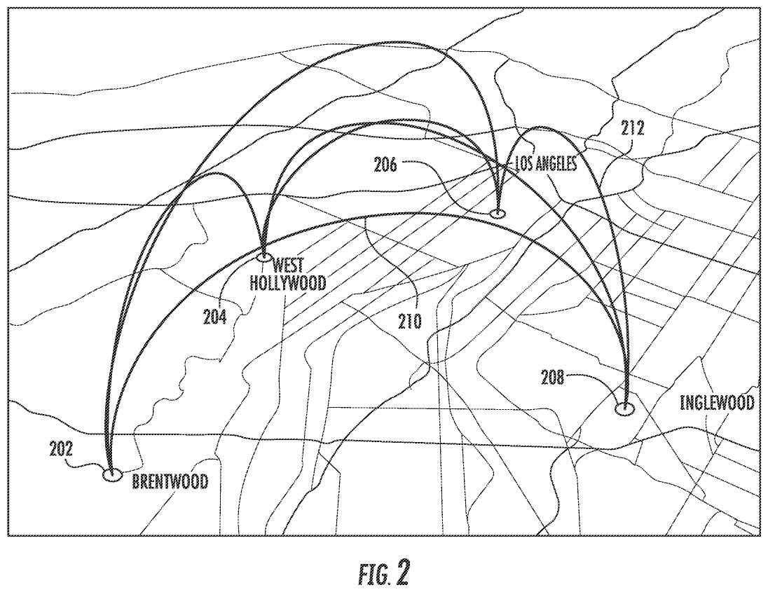

By way of example, FIG. 2 depicts a graphical diagram of an example set of flight plans between an example set of aerial transport facilities according to example embodiments of the present disclosure. In particular, FIG. 2 provides a simplified illustration of an example fixed infrastructure associated with flight-based transportation in an example metropolitan area. As illustrated in FIG. 2, there are four aerial transport facilities which may be referred to as “skyports.” For example, a first aerial transport facility 202 is located in a neighborhood of the metropolitan area, a second aerial transport facility 204 is located in a second neighborhood, a third aerial transport facility 206 is located in a third neighborhood, and a fourth aerial transport facility 208 is located in a fourth neighborhood. The location and number of aerial transport facilities is provided only as an example. Any number of transportation nodes at any different locations can be used.

Flights are available (e.g., may be pre-planned, determined on demand, etc.) between certain pairs of the aerial transport facility. For example, a flight path 210 exists between the aerial transport facility 202 and the fourth aerial transport facility 208. Likewise, a flight path 212 exists between the fourth aerial transport facility 208 and the third aerial transport facility 206.

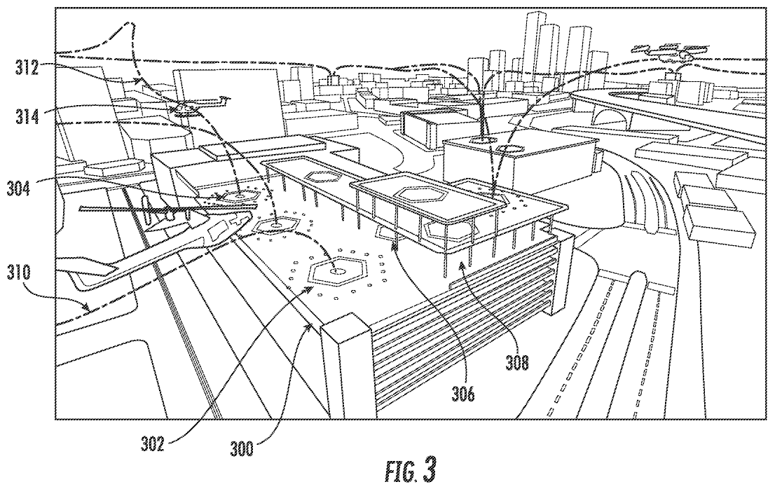

FIG. 3 depicts a graphical diagram of an example aerial transport facility 300 according to example embodiments of the present disclosure. The example aerial transport facility 300 includes a number of take-off/landing pads such as pads 302 and 304. The example aerial transport facility 300 also includes a number of vehicle parking locations such as parking locations 306 and 308. For example, re-fueling, re-charging, or climate control infrastructure may be accessible at each parking location.

Flight trajectories into and out of the aerial transport facility 300 may be defined, configured, assigned, communicated, etc. FIG. 3 illustrates a number of flight trajectories including, for example, trajectories 310 and 312. The trajectories can be fixed or can be dynamically computed. The trajectories can be computed by the aircraft or can be centrally computed and then assigned and communicated to the aircraft. As one example, FIG. 3 illustrates a helicopter 314 taking off from the pad 304 according to the trajectory 312.

Although FIGS. 2 and 3 depict an example fixed infrastructure including an example set of aerial transport facilities, a person of ordinary skill in the art would understand that the fixed infrastructure can include alternative transportation facilities for any transportation modality including, for example, water-based transportation modalities, underground transportation modalities, etc. By way of example, in some implementations, the fixed infrastructure can include a set of waterside transportation facilities placed along one or more coastal regions, neighborhoods, etc. of an urban environment. In addition, or alternatively, and as another example, the fixed infrastructure can include a set of underground transport facilities connected by one or more subway tunnels, etc.

Turning back to FIG. 1, the use of fixed infrastructure can constrain the number and availability of service providers. As such, in some instances, the service entity computing system 102 can initially identify any transportation facilities associated with a first transportation modality (e.g., flight, underground, water modality, etc.) that are relevant to the rider's request. For example, the service entity computing system 102 can identify any transportation facilities that are within a threshold distance from the origin location as candidate departure facilities. Likewise, the service entity computing system 102 can identify any transportation facilities that are within a threshold distance from the destination location as candidate arrival facilities.

The service entity computing system 102 (e.g., an optimization/planning system 130) can pre-determine a number of planned transportation services by the operators. For example, in some implementations, vehicles (e.g., aerial vehicles, water vehicles, etc.) of a ride-sharing network can be scheduled and/or otherwise controlled by the service entity computing system 102 in accordance with the ride sharing network. By way of example, with reference to aerial vehicles, the service entity computing system 102 can generate (e.g., on a daily basis) an initial pre-defined set of flight plans for the aerial vehicles of the ride-sharing network and can add and/or remove passengers from each planned flight. In some implementations, the service entity computing system 102 can dynamically optimize (e.g., via an optimization and planning system 130) planned transportation services by the service providers to account for real-time changes in rider availability and demand. For example, the service entity computing system 102 can dynamically modify the pre-determined flight plans (e.g., delay a planned flight departure by five minutes and/or change a planned flight to an arrival transportation node).

In scenarios in which the first transportation modality operates according to pre-determined plans, after identifying the relevant transportation facilities, the service entity computing system 102 can access a database of pre-determined transportation plans to identify candidate transportation plans between the relevant facilities. For example, the service entity computing system 102 can identify any transportation plans between one of the candidate departure facilities and/or one of the candidate arrival facilities which would satisfy the rider's request, including, for example, any departure or arrival time requests.

In some implementations, for example in which a transportation modality does not have pre-determined plans but instead operates in an “on-demand” nature, the service entity computing system 102 can match (e.g., via a matching and fulfillment system 132, etc.) the rider with a service provider for the transportation modality from a free-floating, dynamic pool of independent service providers. For example, service providers can dynamically opt in and out of the ride sharing network and the service entity computing system 102 can operate to match the passenger with a vehicle of a service provider who is currently opted into the network. The service provider can choose to provide the service to the passenger or decline to provide the service. For example, for alternative modalities such as by aerial vehicles, water-based vehicle, etc., the service entity computing system 102 can match the rider to one of a dynamically changing pool of vehicles (e.g., aerial vehicles, water vehicles, etc.) and the vehicles can choose (e.g., via one or more functional calls to the matching and fulfillment system 132) to provide or decline the proposed transportation service.

The service entity computing system 102 can identify (and/or predict, generate, etc.) a set of candidate transportation plans that can form the basis for building a set of potential itineraries. The service entity computing system 102 can stitch additional transportation legs to each respective candidate transportation plan to generate a plurality of candidate end-to-end itineraries. The service entity computing system 102 can analyze the candidate itineraries to select one or more itineraries that are high quality according to various measures. The service entity computing system 102 can interact with one or more vehicles (e.g., aerial vehicles, ground vehicles, water vehicles, etc.) and/or one or more service provider computing devices 150, 160, 170 to enable the rider to complete at least one of the one or more itineraries.

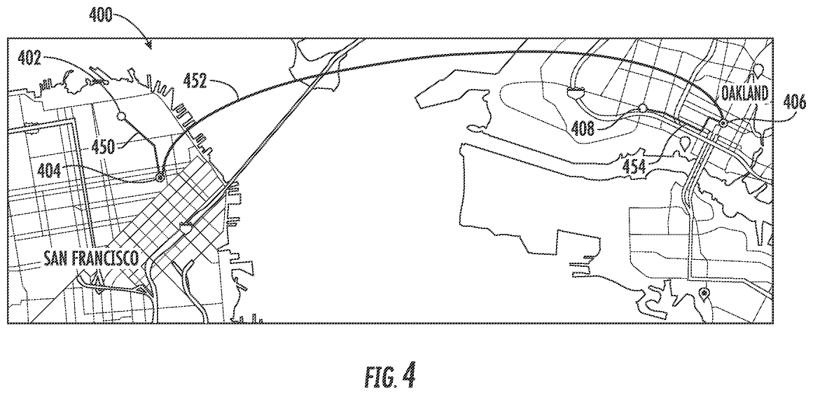

With reference to FIG. 4, FIG. 4 depicts a graphical diagram of an example multi-modal transportation service itinerary 400 according to example embodiments of the present disclosure. The itinerary 400 includes three transportation legs to transport the rider from an origin 402 to a destination 408. In particular, the itinerary 400 includes a first, ground-based (e.g., car-based) transportation leg 450 which transports the rider from the origin 402 to a departure transportation node 404; a second, flight-based transportation leg 452 which transports the rider from the departure transportation node 404 to an arrival transportation node 406; and a third, ground-based (e.g., car-based) transportation leg 454 which transports the rider from the arrival transportation node 406 to the destination 408.

Turning back to FIG. 1, the service entity computing system 102 can include a number of subsystems configured to provide a plurality of backend services to facilitate a transportation service. By way of example, the optimization/planning system 130 can provide a backend itinerary service to generate one or more itineraries for a rider in accordance with the procedures described herein. In addition, the system 130 can provide a backend routing service to determine one or more flight plans, routes, skylanes, sea routes, etc. for vehicles associated with transportation service. The world state system 126 can operate a state monitoring service to maintain data descriptive of a current state of the world (e.g., a predicted transportation demand, flight assignments, operational statuses and locations of a plurality of vehicles, etc.). The forecasting system 128 can operate a forecasting service to generate predictions of transportation demand, weather forecasts, and/or any other future looking data helpful for completing a transportation service.

More particularly, the world state system 126 can operate to maintain data descriptive of a current state of the world. For example, the world state system 126 can generate, collect, and/or maintain data descriptive of predicted rider demand; predicted vehicle provider supply; predicted weather conditions; planned itineraries; pre-determined transportation plans (e.g., flight plans, sea routes) and assignments; current requests; current ground transportation vehicle providers; current transport facility operational statuses (e.g., including re-charging or re-fueling capabilities); current vehicle statuses (e.g., including current fuel or battery level); current operator statuses; current flight states and trajectories; current airspace/water space information; current weather conditions; current communication system behavior/protocols; and/or the like. The world state system 126 can obtain such world state information through communication with some or all of the devices 140, 150, 160, 170, and/or 190. For example, devices 140 can provide current information about riders, devices 150, 160, and 170 can provide current information about service providers, and service provider devices(s) can provide current information about service providers. Devices 190 can provide current information about the status of infrastructure and associated operations/management.

The forecasting system 128 can generate predictions of the demand and supply for transportation services at or between various locations over time. The forecasting system 128 can also generate or supply weather forecasts. The forecasts made by the system 128 can be generated based on historical data and/or through modeling of supply and demand. In some instances, the forecasting system 128 can be referred to as an RMR system, where RMR refers to “routing, matching, and recharging.” The RMR system can be able to simulate the behavior of a full day of activity across multiple ride share networks. By way of example, the RMR system can have access to one or more trajectory prediction libraries that can include one or more models or algorithms configured to determine the predicted behavior of one or more entities associated with a transportation service.

The optimization/planning system 130 can generate transportation plans for various transportation assets and/or can generate itineraries for riders. For example, the optimization/planning system 130 can perform flight planning, sea route planning, etc. As another example, optimization/planning system 130 can plan or manage/optimize itineraries which include interactions between riders, operators, and service providers across multiple modes of transportation.

The matching and fulfillment system 132 can match a rider with a service provider and vehicle for each of the different transportation modalities. For example, each respective matching system 134 can communicate with the corresponding service provider computing devices 150, 160, 170 and/or rider computing device(s) 140 via one or more APIs or connections. Each matching system 134 can communicate trajectories and/or assignments to the corresponding rider, vehicles, service providers etc. Thus, the matching and fulfillment system 132 can perform or handle assignment of ground transportation, flight trajectories, waterway routes, take-off/landing, etc.

The monitoring and mitigation system 136 can perform monitoring of rider itineraries and can perform mitigation when an itinerary is subject to significant delay (e.g., one of the legs fails to succeed). Thus, the monitoring and mitigation system 136 can perform situation awareness, advisories, adjustments and the like. The monitoring and mitigation system 136 can trigger alerts and actions sent to the devices 140, 150, 160, 170, and 190. For example, entities such as riders, service providers, operators, operations personnel, etc. can be alerted when an object has been left behind (e.g., left on a transportation leg preceding a current transportation leg) by a rider. Thus, the monitoring and mitigation system 136 can have additional control over the movement of aerial vehicles, ground vehicles, water vehicles, air traffic controllers, pilots, and riders.

The object tracking system 138 can be configured to track the progress of a rider and one or more objects accompanying the rider as the rider and the accompanying object(s) progress through a multi-modal transportation itinerary. For example, as described in further detail herein, object tracking system 138 can generate an object profile associating a rider with one or more object(s) to accompany the rider during a multi-modal transportation service. The object tracking system 138 can obtain a location of the rider to determine when the rider is transitioning between one or more legs of the multi-modal transportation itinerary.

By way of example, with reference to FIG. 4, a transitioning point can include any of the stops 402, 404, 406, and/or 408 along the multi-modal transportation service itinerary. A first transitioning point can include an origin 402 when the rider transitions from a stationary location (e.g., the origin location 402) to the first transportation leg 450. A second transitioning point can include a departure transportation node 404. The departure transportation node 404, for example, can include a first aerial transport facility (and/or other alternative transportation facilities such as waterside facilities, etc.) where the rider transitions from the first (ground-based) transportation leg to a second (flight-based, water-based, etc.) transportation leg 452. A third transitioning point can include an arrival transportation node 406. The arrival transportation node 406, for example, can include a second aerial transport facility (and/or other alternative transportation facilities such as waterside facilities, etc.) where the rider transitions from the second (flight-based, water-based, etc.) transportation leg to a third (ground-based) transportation leg 454. And, a fourth transitioning point can include a destination 408 when the rider transitions from the third (ground-based) transportation leg 454 to another stationary location.

Turning back the FIG. 1, the object tracking system 138 can obtain identify when the rider is at a transitioning point and, in response, obtain object data associated with the object(s) of the user-object profile. Based on the object data, the object tracking system 138 can determine an object location associated with each of the object(s). The object tracking system 138 can compare the object location the rider's location to determine whether the object(s) have progressed with the rider to the current transitioning point. The object tracking system 138 can control the progress of the rider through the multi-modal transportation itinerary and, in some instances, initiate one or more object-check actions, based on whether the object(s) have progressed with the rider.

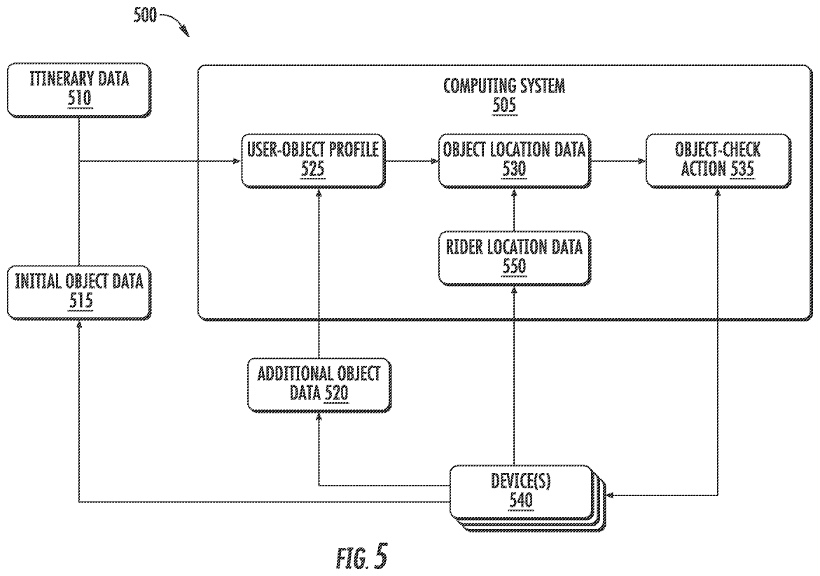

More particularly, FIG. 5 depicts a dataflow diagram 500 for initiating an object-check action according to example implementations of the present disclosure. As depicted, a computing system 505 can obtain itinerary data 510, initial object data 515, and additional object data 520. The computing system 505 can generate a user-object profile 525, determine location data 530, and determine an object-check action 535. The object-check action 535 can include interacting with one or more device(s) 540. For example, the computing system 505 can include a service entity computing system (e.g., service entity computing system 102, object tracking system 138, etc. of FIG. 1) and/or one or more sub-systems or services thereof. The computing system 505 can be communicatively connected (e.g., via one or more networks 180 of FIG. 1) to the one or more device(s) 540. The device(s), for example, can include one or more devices associated with a ride-sharing network such as, for example, the one or more rider computing devices 140, service provider devices 150, 160, 170, and/or infrastructure and operations computing devices 190 of FIG. 1.

The computing system 505 can facilitate the ability of a rider to receive transportation via one or more of the transportation legs included in a multi-modal transportation service itinerary. For example, the computing system 505 can obtain itinerary data 510 indicative of a multi-modal transportation itinerary for facilitating a multi-modal transportation service for the rider. The itinerary data 510 can identify at least a first transportation leg, a second transportation leg, and/or a third transportation leg. The itinerary data 510 can include information associated with each transportation leg such as, for example, an origin location, destination location, a transportation facility (e.g., aerial facility, water facility, etc.), a transportation modality, etc. For example, the itinerary data 510 can include one or more routes for each transportation leg of the multi-modal transportation itinerary. The one or more routes can include a first route for the first transportation leg, a second route for the second transportation leg, and/or a third route for the third transportation leg. Each route can indicate a transition point between one transportation leg and a subsequent transportation leg of the multi-modal transportation itinerary.

The computing system 505 can receive object data 515, 520 (e.g., quantity data and/or attribute data) associated with one or more objects to accompany the rider for the transportation service at any time before (e.g., initial object data 515) and/or during (e.g., additional object data 520) the multi-modal transportation service. The object data 515 can include quantity data, attribute data, and/or other data associated with one or more object(s) to accompany the rider during the transpiration service. The quantity data, for example, can indicate a number of objects to accompany the rider during the transportation service. The attribute data can identify one or more object attributes (e.g., size, weight, visual characteristics (e.g., color, shape, etc.), etc.) for each of the number of objects.

For example, the initial object data 515 and/or the additional object data 520 can include input data received from one or more devices 540 associated with one or more participants of a respective transportation leg of the multi-modal transportation itinerary and/or sensor data gathered by the one or more sensors of a vehicle and/or infrastructure device associated with a respective transportation leg of the multi-modal transportation itinerary.

For example, the multi-modal transportation itinerary can include a plurality of participants. The plurality of participants can include the rider (e.g., participating by receiving the transportation service), one or more vehicle operators (e.g., an operator of a ground vehicle, an aerial vehicle, water vehicle, etc. assigned to perform at least one transportation leg of the itinerary, etc.), and/or one or more infrastructure personnel. The one or more infrastructure personnel can include one or more transportation facility personnel (e.g., aerial transport personnel, water transport personnel, underground transport personnel, etc.) assigned to facilitate the transfer of the rider and/or object(s) from a ground transportation service to an alternative transportation service (aerial transportation service, water transportation service, etc.). By way of example, the one or more infrastructure personnel can include a greeter assigned to direct the rider upon arrival at a transportation facility (e.g., aerial transport facility, water transport facility, etc.), a service desk operator assigned to check-in the rider for an alternative transport (e.g., aerial transport, water transport, etc.), etc.

Each of the plurality of participants can be associated with a respective device. By way of example, the rider can be associated with the rider device, as described above, with which the rider can communicate with the computing system 505. The vehicle operators can be associated with a service provider computing device (e.g., onboard tablet, mobile phone, etc.). And, the infrastructure personnel can be associated with an infrastructure and operations computing device (e.g., a greeter can be associated with a greeter device, a service desk operator can be associated with a terminal device, etc.).

Each of the devices (e.g., rider device, operator devices, and/or infrastructure devices) can be configured to display one or more user interfaces. Each participant of the multi-modal transportation itinerary can interact with the one or more user interfaces to communicate with the computing system 505. For instance, the participants can input object data 515, 520 to indicative of the number and/or attributes of one or more objects at one or more points along the multi-modal transportation itinerary. In this manner, the input data can include data received from: a rider device and input by the rider; a service provider device and input by a vehicle operator; or an infrastructure device and input by a greeter and/or any other facility personnel. The input data can be obtained at one or more times throughout a transportation service.

In addition, or alternatively, the object data 515, 520 can include sensor data gathered at one or more times throughout a transportation service. The sensor data, for example, can include data gathered by one or more sensors of a transportation vehicle or infrastructure associated with a respective transportation leg of the multi-modal transportation itinerary. For example, as discussed herein, the transportation vehicle and/or infrastructure associated with each respective transportation leg of the multi-modal transportation itinerary can include one or more sensors. The one or more sensors can include any sensor configured to detect the quantity and/or attributes of the one or more objects accompanying the rider. For instance, the sensors can include cameras, weighing devices, location sensor(s) (e.g., radio frequency identification tags, global positioning devices, etc.), suspension sensor(s) (e.g., configured to provide compression information indicative of the presence of objects within a vehicle, etc.), etc.

For example, the sensor data can include image data and/or weight data indicative of the presences and/or one or more attributes of the one or more object(s). As an example, the computing system 505 can obtain object data 515, 520 including image data indicative of a number of object accompanying the rider (e.g., quantity data) and/or one or more attributes (e.g., attribute data) of each of the number of objects accompanying the rider. By way of example, the image data can be indicative of one or more visual attributes of the one or more objects. The visual attributes can include at least one of a shape attribute, a color attribute, and/or a size attribute. As another example, the computing system 505 can obtain object data 515, 520 including weight data indicative of the number of objects accompanying the rider and/or the weight of the number of object(s) accompanying the rider.

The computing system 505 can receive initial object data 515 associated with one or more objects to accompany the rider for the transportation service at any time before the beginning of the multi-modal transportation service. For example, the computing system 505 can obtain request data indicative of a request for the transportation service for a rider. In some implementations, the rider associated with the request can provide (e.g., via input to a user interface of a rider device 140) the initial object data 515 associated with the object(s) to accompany the rider for the transportation service with the request for the transportation service. As an example, the rider can specify (e.g., via input data to the rider device) a quantity and/or type of object(s) for the transportation service to satisfy a weight limit for a transportation leg (e.g., a flight leg, a water-based leg, etc.), a personal item limit for the transportation leg, etc. and/or an inquiry associated with such limits. In addition, or alternatively, the rider can be associated with a rider account of the computing system 505. The rider account can include the initial object data 515 associated with the object(s) to accompany the rider for the transportation service. In such a case, the computing system 505 can obtain the initial object data 515 by accessing the rider account associated with the rider.

In some implementations, the initial object data 515 can include sensor data obtained before the transportation service. The sensor data, for example, can include data gathered by one or more sensors of a first transportation vehicle assigned to provide a first transportation leg of the multi-modal transportation itinerary. For example, the initial object data 515 can include image data obtained via one or more cameras of the first transportation vehicle, weight data obtained via one or more weight sensors of the first transportation vehicle, etc. In addition, or alternatively, the sensor data can include data gathered by one or more sensors of the rider device, or a vehicle service provider device associated with an operator of the first transportation vehicle.

The computing system 505 can obtain additional object data 520 during the rider's progress through the multi-modal transportation service. The additional object data 520 can include input data and/or sensor data gathered by one or more sensors associated with one or more of the transportation modalities (e.g., ground vehicles, aerial vehicles, water-based vehicles, transportation infrastructure, etc.) assigned to perform and/or facilitate a portion of the multi-modal transportation service.

The computing system 505 can generate a user-object profile 525 for the rider based on the initial object data 515 and the multi-modal transportation itinerary (e.g., the itinerary data 510) for facilitating multi-modal transportation of the rider. For example, the user-object profile 525 can be indicative of an association between the rider and the object(s) accompanying the rider during the multi-modal transportation itinerary. The user-object profile 525 can include an identifier for the object(s) accompanying the rider (e.g., a unique identifier indicative of an object (e.g., an object attribute, etc.)) and/or one or more object characteristics as identified by the quantity data and/or attribute data of the initial object data 515. In some implementations, the user-object profile 525 can be updated throughout the multi-modal transportation itinerary based at least in part on the progress of the rider and/or the object(s) accompanying the rider through the multi-modal transportation itinerary.

The computing system 505 can generate the user-object profile 525 based, at least in part, on initial object data 515. The initial object data 515 can include object data initially received for the multi-modal transportation service. By way of example, the initial object data 515 can include quantity and/or attribute data of the request data provided by the rider before the transportation service. As another example, the initial object data can include sensor data received by the computing system 505 before a first vehicle begins the first leg of the transportation service. For instance, the initial object data 515 can include sensor data (e.g., image data, weight data, etc.) obtained by one or more sensors associated with a vehicle assigned to perform the first transportation leg of the multi-modal transportation itinerary and/or a user device of the rider.

In some implementations, the computing system 505 can perform an initial object-check action before generating the user-object profile 525 and/or before providing the first leg of the multi-modal transportation service. The initial object-check action can include comparing the request data (e.g., data input by a rider) with the sensor data (e.g., data received by sensors of a vehicle assigned to perform the first transportation leg) received before the first vehicle begins the first leg of the transportation service. By way of example, the request data can include first quantity data and first attribute data. The first quantity data can include a number of objects input by the rider and the first attribute data can include characteristics for each of the number of objects as specified by the rider. The sensor data can include second quantity data and second attribute data. The second quantity data can include a number of objects as detected by one or more sensors associated with the first transportation leg of the multi-modal transportation itinerary and the first attribute data can include characteristics for each of the number of objects as detected by one or more sensors associated the first transportation leg of the multi-modal transportation itinerary.

The computing system 505 can obtain initial object data 515 including both the input data (e.g., first quantity data and first attribute data) and the sensor data (e.g., second quantity data and second attribute data). For instance, the computing system 505 can determine the initial object-check action before the transportation service based on the request data and the sensor data. As an example, the computing system 505 can determine whether the first quantity data and/or first attribute data corresponds to the second quantity data and/or the second attribute data.

The initial object-check action can include generating the user-object profile 525 and/or initiating one or more preventative actions. In the event that the request data corresponds to the sensor data, the initial object-check action can include generating the user-object profile 525. In the event that the request data does not correspond to the sensor data, the initial object-check action can include initiating the one or more preventative actions. The one or more preventative actions can include notifying the rider, via the rider device, that the sensor data does not correspond to the request data. In addition, or alternatively, the one or more preventative actions can include providing alternative object transportation options for display (e.g., via a rider device). The alternative object transportation options can include alternative recovery methods, as described herein, and/or options to update the multi-modal transportation itinerary (e.g., take a later alternative transportation, pay an extra charge for an increased payload allowance, etc.).

The computing system 505 can initiate the initial object-check action. For instance, the computing system 505 can generate and/or update the user-object profile 525 in the event that the sensor data corresponds to the request data and/or initiate one or more preventative actions in the event that the sensor data does not correspond to the request data. For example, in some implementations, the computing system 505 can generate the user-object profile 525 at booking based on the request data. In such a case, the computing system 505 can update the user-object profile 525 based on the sensor data. For example, the computing system 505 can confirm the first quantity and/or attribute data of the rider-profile 525 based on the obtaining the similar second quantity and/or attribute data. As another example, the computing system 505 can modify the first quantity and/or attribute data of the rider-profile 525 based on the obtaining the different second quantity and/or attribute data.

As another example, the computing system 505 can initiate one or more preventative actions. The preventative action(s) can include providing data indicative of incompatible first/second initial object data to a rider device of the rider and/or another device associated with the first transportation leg (e.g., a service provider device of a vehicle assigned to perform the first transportation leg). The rider device and/or the other device can receive the data indicative of incompatible first/second initial object data and initiate a notification at the respective device notifying the rider, operator, etc. that the first and/or second initial object data do not match.

In some implementations, the computing system 505 can receive intention data in response to the one or more preventative actions (e.g., a notification that the sensor data does not correspond to the request). The intention data can indicate the rider's intention to proceed with the multi-modal transportation itinerary and/or react (e.g., retrieve an undetected bag, leave an additionally detected bag, etc.) to the one or more preventative actions. The computing system 505 can generate/update the user-object profile 525 based, at least in part, on the intention data. For instance, the computing system 505 can generate/update the user-object profile 525 to associate the rider with the second initial object data as indicated by the sensor data in the event that the rider's intention is to proceed with the multi-modal transportation itinerary. In addition, or alternatively, the computing system 505 can generate/update the user-object profile 525 after the rider has reacted to the one or more preventative actions (e.g., by performing another initial object-check action, etc.) in the event the rider's intention is to react to the one or more preventative actions.

The computing system 505 can track the progress of the rider and/or the object(s) accompanying the rider through the multi-modal transportation itinerary based on the user-object profile 525. To do so, the computing system 505 can track the progress of the transportation service. For example, the computing system 505 can track the transportation service of the rider by obtaining rider location data 550 indicative of the location of the rider and/or one or more vehicles associated with the transportation service. For example, the rider location data 550 can be indicative of the presence of the rider at one or more transition points of a multi-modal transportation itinerary. By way of example, the rider location data 550 can be indicative of a beginning of a transportation leg (e.g., departure from an origin location, departure from a transportation facility, etc.), a completion of a transportation leg (e.g., arrival at a transportation facility, arrival at a destination location, etc.), and/or any other transition between two transportation legs (e.g., checking-in operation, etc.). In some implementations, the progress of the rider can correspond to the progress of the transportation service. For instance, the progress of the rider and/or the progress of the transportation service can be the same.

The progress of the transportation service (and/or the rider) can be tracked through various location sensors (e.g., global positioning sensors, inertial measurement sensors, etc.) of one or more devices 540 (e.g., the rider device, service provider devices, infrastructure devices, etc.) associated with the multi-modal transportation itinerary. In some implementations, the progress of the transportation service (and/or the rider) can be tracked through user input (e.g., notifying that the transportation leg has been completed) to one or more of the devices 540 associated with the transportation service. The input, for example, can be provided by a vehicle operator (e.g., a driver, pilot, remote operator, etc.) to a service provider device, by the rider to a rider device, and/or by personnel (e.g., greeter, service desk operator, etc.) at a transportation facility to an infrastructure device (e.g., greeter device, terminal device, etc.), etc.

The progress of the transportation service can be indicative of the location of a vehicle and/or the rider along the multi-modal transportation service. In this manner, the computing system 505 can identify a completion of a (first, second, third, etc.) transportation leg of the multi-modal transportation itinerary. For instance, the computing system 505 can detect the arrival of a first vehicle (e.g., assigned to perform the first transportation leg of the multi-modal transportation itinerary) at an origin location of the rider and/or a departure facility; the arrival of a second vehicle (e.g., assigned to perform the second transportation leg of the multi-modal transportation itinerary) at the departure facility and/or an arrival facility; the arrival of a third vehicle (e.g., assigned to perform the third transportation leg of the multi-modal transportation itinerary) at the arrival facility and/or a destination location of the rider; etc.

Upon identifying a completion of a (e.g., first, second, third, etc.) transportation leg of the multi-modal transportation itinerary (e.g., based on the rider location data 550), the computing system 505 can determine an object-check action 535. The object-check action 535 can be determined by comparing the progress of the rider (e.g., as indicated by the rider location data 550) and the one or more object(s) accompanying the rider along the transportation service (e.g., as indicated by object location data 530). By way of example, the progress of the rider along the transportation service can include the progress of the transportation service, whereas the progress of the object(s) accompanying the rider can include the progress of the transportation service and/or an indication that the object(s)'s progress is behind the progress of the transportation service (e.g., the object(s) are still associated with a previous transportation leg occurring before the current transportation leg of the rider and/or transportation service).

The computing system 505 can determine an object-check action 535 by obtaining additional object data 520 associated with the object(s). The additional object data 520 can be obtained after the completion of a respective transportation leg and/or during the transition between respective transportation legs of the multi-modal transportation itinerary. The additional object data 520 can include sensor data obtained from various sensors (e.g., cameras, weight sensors, suspension sensors, etc.) associated with a vehicle and/or infrastructure associated with the respective legs. For instance, the additional object data 520 can include the sensor data, described herein, obtained after the generation of the user-object profile 525. The sensor data can include data indicative of one or more object characteristics (e.g., visual (e.g., size, shape, color, etc.), weight, etc.) associated with one or more of the object(s) at a location relative to the multi-modal transportation itinerary (e.g., in a vehicle of a respective leg of the transportation service, along the route of the transportation service, etc.).

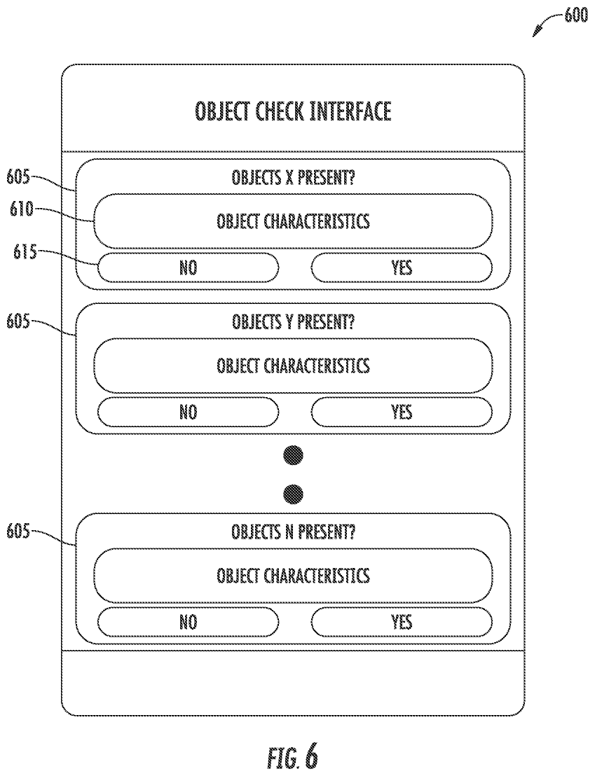

In addition, or alternatively, the additional object data 520 can include input data (e.g., notifying that the object(s) are cleared from the vehicle or remain in the vehicle) provided by an operator, rider, and/or other personnel associated with the respective legs of the multi-modal transportation itinerary. For instance, the additional object data 520 can be input by an operator, rider, and/or other personnel to a device(s) 540 via an object-check interface. By way of example, FIG. 6 depicts an object check user interface 600 according to aspects of the present disclosure. The object check user interface 600 can present one or more interactive object portions 605 (e.g., touch screen buttons) for each object of the user-object profile. Each interactive object portion 605 can present one or more object characteristics 610 (e.g., one or more object attributes such as visual characteristics, an image, etc.) associated with a respective object and one or more interactive options 615. An operator, rider, and/or other personnel can interact with the object check user interface 600 by selecting an interactive option 615 indicative of whether an object is present (e.g., with a rider, within a vehicle, within a transportation facility, etc.) at one or more portions of the multi-modal transportation itinerary.

For example, a computing system (e.g., computing system 505 of FIG. 5) can trigger one or more devices associated with a transitioning point of a multi-modal transportation itinerary to present the object check user interface 600. The computing system can trigger the presentation of the object check user interface 600 in response to determining that the rider has reached the transitioning point of the multi-modal transportation itinerary. An operator, rider, and/or other personnel can interact with the object check user interface 600 to provide real-time object location data to the computing system 505.

For example, turning back to FIG. 5, the computing system 505 can determine object location data 550 indicative of a relative location of at least one of the one or more objects to the rider based, at least in part, on the additional object data 520, the user-object profile 525, and/or at least one transportation leg (e.g., as indicated by the rider location data 550). For example, the computing system 505 can identify the completion of at least one transportation leg of the multi-modal transportation itinerary (e.g., based on the rider location data 550). The computing system 505 can determine a rider location based, at least in part, on the at least one transportation leg. The object location data 530 can identify a location of an object relative to the rider location.

The computing system 505 can determine the object location data 530 by comparing the additional object data 520 to the user-object profile 525. For example, the computing system 505 can identify one or more objects associated with a rider at a location along the multi-modal transportation itinerary by comparing one or more object characteristics (e.g., quantity data, attribute data, etc.) of the additional object data 520 to the object characteristics of the user-object profile 525.

As an example, the additional object data 520 can be indicative of the presence of an object (e.g., as identified by input data, sensor data, etc.) within a vehicle or infrastructure associated with a transportation leg of the multi-modal transportation itinerary. For instance, the additional object data 520 can include input data from one or more participants of the at least one transportation leg and can be provided after the one or more participants manually check for the presence of the object(s) along the multi-modal transportation itinerary. By way of example, the additional object data 520 can include input data from a vehicle operator indicating that one or more of the object(s) are/are not present within a vehicle associated with the vehicle operator. The computing system 505 can determine the object location data 530 for each of the object(s) accompanying the rider along the multi-modal transportation service by comparing the input data to the user-object profile 525 (e.g., if the one or more objects are not present, are transitioning to another transportation leg with the rider, etc.).

As another example, the additional object data 520 can include sensor data from one or more sensors associated with a portion of the multi-modal transportation itinerary. The computing system 505 can determine an object's location along the multi-modal transportation service by comparing one or more attributes (e.g., visual characteristics, weight, etc.) of the additional object data 520 to the user-object profile 525. For example, the computing system 505 can compare one or more attributes (e.g., visual characteristics, weight, etc.) of the additional object data 520 to the user-object profile 525 to identify one or more object(s) of the user-object profile 525 along the portion of the multi-modal transportation itinerary.

The computing system 505 can compare an object's location along the multi-modal transportation itinerary (e.g., as identified by the object location data 530) to the rider location to determine the object location data 530. The object location data 530 can indicate whether the object(s) to accompany the rider during the multi-modal transportation itinerary (e.g., as identified by the user-object profile 525) are within or outside an acceptable relative location range. For example, the object location data 530 can be indicative of the locational relationship between the object(s) and/or the rider. It can include an indication of whether the object(s) remain with the rider and/or have been separated from the rider. For instance, the relative location can include a distance between the rider and/or the object(s), a respective transportation leg associated with the rider and/or one or more object(s), etc. An acceptable relative location range can be a distance and/or a progress along the transportation itinerary. For instance, the acceptable relative location range can include an expected maximum distance (e.g., distance between a rider and/or a baggage area of a vehicle, transportation infrastructure, etc.) between the rider and/or the one or more object(s) accompanying the rider. In addition, or alternatively, the acceptable relative location range can include the current transportation leg associated with the rider. For instance, the acceptable relative location range can be indicative of the progress of the rider along the multi-modal transportation itinerary (e.g., as identified by the rider location data 550).

The computing system 505 can identify the presence of the object(s) with the rider and/or a separation of the object(s) from the rider based on the object location data 530 and the acceptable relative location range. For instance, the computing system 505 can determine that the object(s) are with a rider if the object location data 530 is indicative of a relative location within the acceptable relative location range. In addition, or alternatively, the computing system 505 can determine that the object(s) are separated from the rider if the object location data 530 is indicative of a relative location outside of the acceptable relative location range.

As an example, the object location data 530 can indicate the presence of an object within a vehicle assigned to perform a first transportation leg of the multi-modal transportation itinerary and that the rider location is between the first transportation leg and the second transportation leg (e.g., during a transportation leg transfer). The acceptable relative location range can indicate the portion of the multi-modal transportation itinerary between the first transportation leg and the second transportation leg (e.g., the progress of the rider). In such a case, the object location data 530 can indicate that the object is separated from the rider because the location of the object is outside of the acceptable relative location range.

The computing system 505 can determine an object-check action 535 based at least in part on the multi-modal transportation itinerary (e.g., a respective leg of the multi-modal transportation itinerary), the user-object profile 525, and/or the object location data 530. For instance, the object-check action 535 can be based on the progress of the rider and/or the progress of the object(s) accompanying the rider. An object-check action 535 can include one or more facilitating actions to further the multi-modal transportation itinerary, one or more blocking actions to block one or more aspects of the transportation service, and/or one or more recovery actions to recover one or more separated object(s). For instance, the object-check action 535 can include providing a notification to a device (e.g., a rider device associated with the rider, vehicle device associated with a vehicle, infrastructure device associated with a transportation facility, etc.), blocking an action of a vehicle, rider, operator, or personnel associated with the transportation service, facilitating the progress of the rider through the multi-modal transportation itinerary, and/or facilitating the recovery of one or more separated objects. The object-check action 535 can be determined based, at least in part, on a comparison between the progress of the rider (e.g., rider location data 550) and/or the progress of the object(s) accompanying the rider (e.g., the object location data 530).

For example, the computing system 505 can facilitate the multi-modal transportation itinerary in the event that the object location data 530 is indicative of the object(s)'s relative location within the acceptable relative location range (e.g., within a threshold distance, matching the rider's progress, etc.). For example, if the object location data 530 is indicative of an object's relative location that is within the acceptable relative location range, the object-check action 535 can include providing for display a portion of the itinerary data 510 indicative of a transportation leg subsequent to the current transportation leg of the multi-modal transportation itinerary. For instance, if the rider has all of the object(s) identified by the user-object profile 525, the computing system 505 can display itinerary information that was not already available to the rider (e.g., aircraft number, seat assignment, vehicle identifier, driver name, etc.).

The computing system 505 can perform one or more blockings actions and/or recovery actions in the event that the object location data 530 is indicative of an object's relative location outside of the acceptable relative location range (e.g., outside the threshold distance, not matching the rider's progress, etc.). For example, if the object location data 530 is indicative of an object's relative location that is outside an acceptable relative location range (e.g., outside a threshold distance, associated with a transportation leg preceding the current transportation leg of the rider and/or multi-modal transportation itinerary, and/or the rider's progress and/or the object's progress not otherwise matching, etc.), the object-check action 535 can include preventing the progression of the multi-modal transportation for the rider (e.g., prevent display of further details about a subsequent transportation leg, etc.) and/or preventing a vehicle associated with the preceding transportation leg (ground vehicle, aerial vehicle, water vehicle, etc.) from ending the current transportation service and/or starting a new transportation service.

By way of example, the object-check action 535 can include blocking the commencement of a transportation leg subsequent to the at least on current transportation leg. This can include preventing the presentation of details about the subsequent transportation leg, preventing/delaying the departure of subsequent transportation leg, etc. via a user interface of the rider device. For example, a user interface element associated with the subsequent transportation leg (e.g., flight identifier information, vehicle/driver identifier information, etc.) can be deemphasized (e.g., greyed-out, dashed, etc.) and/or removed from the user interface. In some implementations, one or more interactive elements associated with the subsequent transportation leg can be deactivated and/or removed. For example, a check-in element for the rider can be deactivated and/or removed, a drive contact element for contacting a ground-vehicle operator can be deactivated and/or removed, etc.

In some implementations, another party of the multi-modal transportation service can be prevented from taking an action. For example, a greeter and/or other personnel may be prevented from checking-in the rider to the subsequent transportation leg (e.g., boarding/checking-into the flight leg, boarding/booking a third leg ground vehicle, etc.), without some action by the rider (e.g., to retrieve the item, indicate an intention to proceed without it, etc.). Thus, a rider may not be able to begin/complete the subsequent leg of the multi-modal transportation service in the event an item is not recovered from the previous/current leg.

In addition, or alternatively, a blocking action can include preventing a vehicle operator from ending a service assignment and/or beginning a new service assignment until a rider (and/or infrastructure personnel (e.g., a greeter and/or other personnel, etc.)) has acknowledged that an object has been separated from the rider. In some implementations, the rider can immediately retrieve the object(s). The computing system 505 can obtain additional object data 520 indicative of the retrieval. In response, the computing system 505 can enable (e.g., allow the termination of the service assignment and/or the acceptance of a new service assignment) the vehicle, vehicle operator, other personnel to end the current transportation service and/or accept another transportation service (e.g., to transport another rider).

As another example, the object-check action 535 can include one or more object recovery actions. The one or more object recovery actions can include providing a notification to one or more transportation leg participants (e.g., the rider, a vehicle operator, a greeter at a transportation facility, etc.) and/or obtaining response data indicative of an acknowledgment of whether the relative location of the object(s) are within or outside an acceptable relative location range (e.g., with the rider, separated from the rider, etc.). In some implementations, the object-check action 535 can prevent a vehicle from ending the current trip and/or starting a new trip until an acknowledgement (e.g., a notification that the passenger has obtained the object(s) or that the rider has chosen to continue the trip and/or choose an alternative recovery method, etc.) is received from the rider associated with the separated object.

For instance, the computing system 505 can provide data indicative of the relative location(s) of the object(s) to one or more devices associated with one or more participants of the transportation leg. The one or more participants of the transportation leg, for example, can include the rider, a vehicle operator, and/or personnel associated with a transportation facility. In some implementations, the data can include a message indicating that the relative location of an object is outside of the acceptable relative location range. For example, the data can be a notification that the rider has been separated from the object(s).

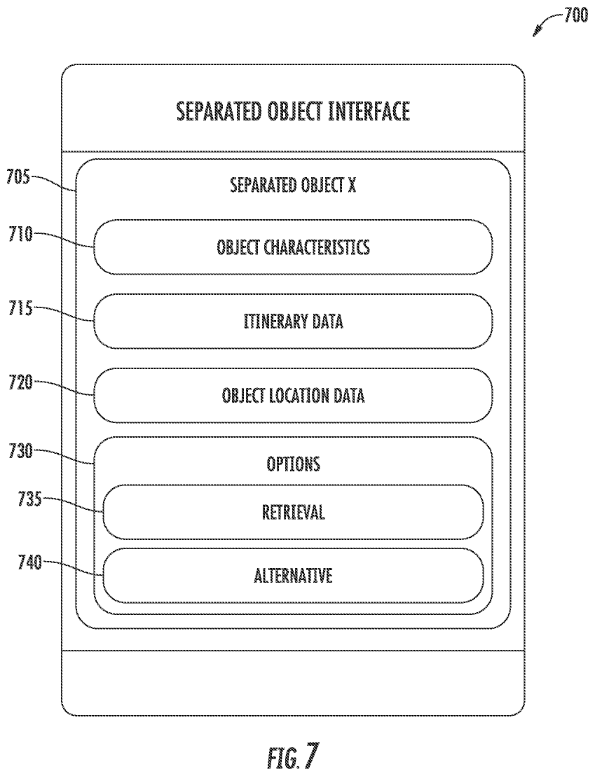

By way of example, FIG. 7 depicts a separated object user interface 700 according to aspects of the present disclosure. The separated object user interface 700 can present one or more interactive separated object portions 705 (e.g., touch screen buttons) for each separated object of the user-object profile. Each interactive object portion 705 can present one or more object characteristics 710 (e.g., one or more object attributes such as visual characteristics, an image, etc.) associated with the separated object, itinerary data 715 identifying the current location of the rider, object location data 720 identifying the predicted location of the object, and one or more interactive options 730. The one or more interactive option 730 can include a retrieval option 735 and/or an alternative retrieval option 740. An operator, rider, and/or other personnel can interact with the separated object user interface 700 by selecting an interactive option 730 indicative of whether a rider intends to retrieve the object immediately (e.g., by selecting the retrieval option 735) or proceed with the transportation service and pursue an alternative retrieval method (e.g., by selecting alternative retrieval option 740).

Turning back to FIG. 5, the computing system 505 can obtain response data indicative of a response to the message. For example, the response data can be obtained via input to any device (e.g., operator device, rider device, infrastructure device (e.g., a greeter device, etc.), etc.) associated with a participant of the at least one transportation leg associated with the object-check action 535. By way of example, the user input can include an acknowledgement by a participant (e.g., rider, operator, personnel, etc.) of the notification.

In some implementations, acknowledging that the object(s) have been separated can include a selection of a recovery option for an object that has been separated from the rider. For instance, the computing system 505 can generate recovery data including one or more alternative object transportation options. The recovery data can include cost prediction(s) and/or time prediction(s) associated with each of the one or more alternative object transportation options. The computing system 505 can provide the recovery data to the rider device for display by the user interface of the rider device.

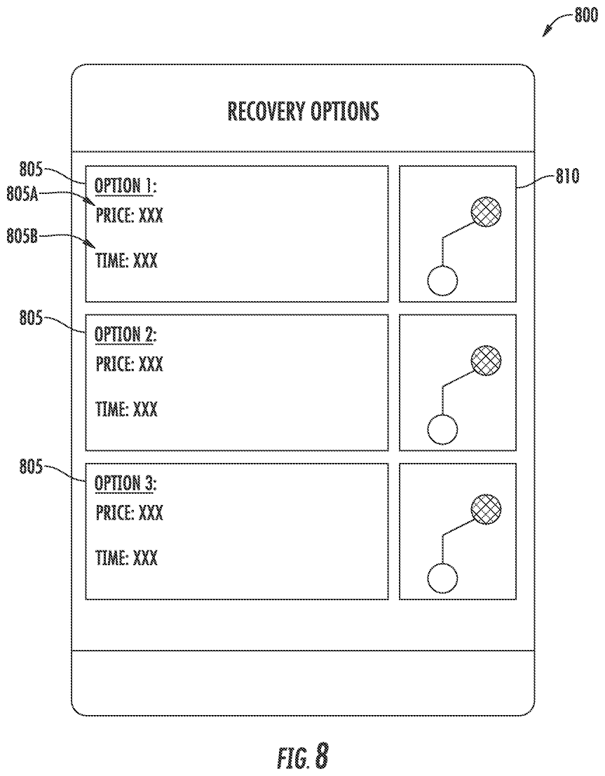

As an example, FIG. 8 depicts an object recovery user interface 800 according to aspects of the present disclosure. The object recovery user interface 800 can present one or more alternative object recovery option(s) 805 (e.g., interactive touch screen sections) for each separated object of the user-object profile. Each alternative object recovery option(s) 805 can include one or more cost prediction(s) 805A (e.g., one or more additional cost for delivering a lost object to the rider) associated with the separated object, one or more cost prediction(s) 805B (e.g., one or more estimated times of arrival for the one or more separated objects), and/or one or more route predictions 810 (e.g., one or more estimated routes for the delivery of the one or more separated objects). An operator, rider, and/or other personnel can interact with the object recovery user interface 800 by selecting an alternative object recovery option(s) 805. For instance, a rider can select a recovery option from the one or more recovery options and, in response the rider device can provide recovery data indicative of the selected recovery option to the computing system 505. The alternative object transportation option(s) 805, for example, can include delivery of the object(s) to the rider's destination location, delivery of the object(s) to a third location obtained from the rider (e.g., through user input of an address (e.g., to a hotel, a rider's home, etc.)), and/or obtaining the object(s) from a recovery facility (e.g., a customer service center, transportation facility, etc.).

Turning back to FIG. 5, the computing system 505 can obtain a response data indicative of the rider's choice of an alternative recovery option for the separated object. The computing system 505 can generate an alternative object itinerary based on the multi-modal transportation itinerary of the rider and/or the one or more alternative object transportation options for the separated object. The computing system 505 can provide data indicative of the alternative object itinerary to the rider device for display via the user interface.

In some implementations, the computing system 505 can determine an object-check action 535 based on a prior object-check action. For instance, the rider response data received in response to a prior object-check action can be indicative of the rider proceeding with the transportation itinerary without the separated object(s) and/or a selection of one or more alternative transportation options for the separated object(s). In such a case, the object-check action 535 can include updating the user-object profile 525 to include data indicative of the rider response data. Additionally, or alternatively, the object-check action 535 can include providing a notification for display via a rider device and/or obtaining a rider response to the notification.

The computing system 505 can obtain additional object data 520 and determine and/or initiate one or more object-check action(s) 535 at one or more times as the rider progresses through the multi-modal transportation itinerary. As an example, the computing system 505 can obtain additional object data 520 and determine and/or initiate one or more object-check action(s) 535 before, after, during, and/or between each transportation leg of the multi-modal transportation itinerary.

By way of example, the computing system 505 can determine a first object-check action after a first transportation leg. To do so, the computing system 505 can obtain additional object data 520 after the first transportation leg of the multi-modal transportation itinerary. For example, the first transportation leg can be a ground transportation leg from an origin location to a first transportation facility. The additional object data 520 can include input data from a vehicle operator assigned to perform the first transportation leg and/or a greeter assigned to direct the rider to the second transportation leg of the multi-modal transportation itinerary. In addition, or alternatively, the additional object data 520 can include sensor data obtained via one or more sensors associated with the first transportation leg. The one or more sensors can include one or more vehicle sensors of the ground vehicle assigned to perform the first transportation leg and/or one or more facility sensors of the first transportation facility.

The first object-check action can include providing data indicative of the relative location of an object to one or more computing devices 540 associated with one or more participants of the first transportation leg. The one or more participants can include the rider, the operator of the ground vehicle assigned to perform the first transportation leg, and/or transportation facility personnel associated with the transportation facility. By way of example, the first object-check action can include providing a notification to one or more of the participants (e.g., a message that object(s) are separated from the rider, etc.), obtaining a response from one or more of the participants (e.g., the rider choosing an alternate recovery option), and/or performing a blocking action such as preventing details of a subsequent transportation leg to the current transportation leg from displaying at the rider device, preventing the vehicle operator from accepting another transportation service assignment, etc. The computing system 505 can initiate the first object-check action to prevent the separation and/or enable the recovery of the one or more objects intended to accompany the rider during the multi-modal transportation service.

As another example, an object-check action 535 can be initiated between a ground transportation leg and another transportation leg of an alternative modality. For example, the computing system 505 can identify a checking-in operation associated with the rider. The checking-in operation can include a process by which the rider checks into (e.g., confirms the rider's arrival, etc.) the other transportation leg of the multi-modal transportation itinerary. For instance, the checking-in operation can be performed at a transportation facility associated with the other transportation leg (e.g., associated with an alternative modality/medium, etc.) of the multi-modal transportation itinerary. The computing system 505 can determine a second object-check action in response to identifying the checking-in operation associated with the rider.

The computing system 505 can determine the second object-check action based, at least in part, on object-check action(s) preceding the second object-check action. For example, the computing system 505 can obtain data indicative of a first object-check action determined based, at least in part, on the first transportation leg, the user-object profile 525, and first leg object location data 530 indicative of a relative location of an object to a rider after the first transportation leg. The computing system 505 can determine a second object-check action based, at least in part, on the first object-check action and the checking-in operation associated with the rider.

For example, the computing system 505 can determine that the relative location of the object after the first transportation leg was outside of an acceptable relative location range based, at least in part, on the first object-check action. For instance, the first object-check action can include providing data indicative of a separated object to the rider device. In response, the computing system 505 can determine that the relative location of the object after the first transportation leg was outside of the acceptable relative location range.

The computing system 505 can determine the second object-check action based, at least in part, on whether the first object-check action was addressed. For example, the computing system 505 can obtain additional object data 520 and determine object location data 530 for the one or more objects identified by the user-object profile 525 during the checking-in operation. The computing system 505 can determine that the first object-check action was not addressed in the event that an object is currently outside of the acceptable relative location range. In addition, or alternatively, the computing system 505 can determine that the first object-check action was addressed in the event that the object is currently within the acceptable relative location range.

In the event that the first object-check action was not addressed, the computing system 505 can provide data indicative of the relative location of the object to at least one device associated with the checking-in operation. For example, the checking-in operation can include a self-checking operation (e.g., via the rider device) and/or a checking-in operation via one or more infrastructure and operations devices (e.g., a terminal device, a greeter device, etc.). The computing system 505 can determine which device is being used to check-in and provide data indicative of the relative location of the object to that device.

By way of example, if there are separated object(s), the computing system 505 can cause a message directing the rider to retrieve the separated object(s) to display on the device associated with the checking-in operation (e.g., a terminal device, a rider device, etc.). If the rider chooses not to retrieve the object(s) immediately, the rider can be presented with alternative transportation options for the object(s). In a similar manner, a notification about the separated object(s) can be provided for display to transportation facility personnel (e.g., greeter, service desk operator, etc.) via an infrastructure and operations device (e.g., greeter device, terminal device, etc.). The computing system 505 can update the rider's multi-modal transportation itinerary based in part on the rider response to the first and/or second object-check action. For instance, if a rider chooses to immediately retrieve object(s) from a prior transportation leg, the computing system 505 can determine if the next transportation should be delayed to accommodate the rider and/or if the rider's itinerary should be updated (e.g., for a later flight, later take-off, etc.).

In some implementations, the first object-check action can be indicative of the object(s) remaining with the rider. In this example, the computing system 505 can provide for the display of information about transportation legs of a different medium/modality (e.g., identity of the rider, weight, boarding time, the door to leave out of, etc.). Further, the computing system 505 can obtain a rider response confirming the information about the trip.

As another example, the object-check action 535 can be determined and/or initiated after the performance of transportation leg (e.g., of an aerial modality, water-based modality, etc.). The object-check action 535 can include notifying the rider and/or transportation facility personnel (e.g., ramp staff, etc.) at an arrival transport facility that an object has been separated from the rider (e.g., the object(s) remain on the vehicle of the previous transportation leg, etc.). For example, the notification to the rider can include a message to the rider to not return to the vehicle to retrieve the luggage (e.g., notifying the rider to instead retrieve the object(s) from transportation facility personnel, etc.). Initiating the object-check action 535 can further include preventing the display of information about a subsequent transportation leg (e.g., driver name, vehicle identifier, etc.) until the rider has retrieved the separated object(s) from the personnel associated with the transportation facility or chosen an alternative recovery method for the object(s). Additionally, or alternatively, the object-check action 535 can include preventing a vehicle (e.g., aerial vehicle, water-based vehicle, underground vehicle, etc.) from commencing a subsequent passenger loading process until all object(s) have been cleared out of the vehicle by riders or personnel associated with the second transportation facility (e.g., ramp staff, etc.).

In some implementations, the computing system 505 can determine a concluding object-check action after the completion of the multi-modal transportation itinerary. To do so, the computing system 505 can obtain object location data 530 associated with one or more of the first transportation legs, the second transportation leg, and/or the third transportation leg of the multi-modal transportation itinerary. For example, the object location data 530 can include a relative location of at least one object of the one or more objects identified by the user-object profile 525 to the rider after and/or during a transition between each of the transportation legs of the multi-modal transportation itinerary.

The computing system 505 can determine whether the at least one object was separated from the rider during the multi-modal transportation service based, at least in part, on the object location data 530. For example, the computing system 505 can determine that the object is a separated object that has been separated from the rider during the transportation service based, at least in part, on the object location data 530. As an example, the relative location of the object can include a relative location outside of an acceptable relative location range at one or more points during the multi-modal transportation service. In the event that the object is not retrieved (e.g., the object is outside the acceptable relative location range after the final transportation leg of the multi-modal transportation itinerary, etc.) the computing system 505 can determine that the object is a separated object.

The computing system 505 can obtain recovery data including one or more alternative object transportation options for the separated object. The computing system 505 can receive a selection of an alternative object transportation option (e.g., at the time the rider is separated from the object, at the end of the multi-modal transportation service, etc.). The computing system 505 can generate an object itinerary for the separated object based, at least in part, on the itinerary data 510 and/or the recovery data (and/or the selected alternative object transportation option). For instance, the object itinerary can include a transportation itinerary from the point at which the object is separated from the rider to a destination (e.g., a destination of the multi-modal transportation itinerary, an alternative rider-provided destination, etc.) associated with the rider. The concluding object-check action can include providing the object itinerary to the rider device for display via the user interface.

By way of example, the computing system 505 can detect the completion of the transportation service (e.g., arrival at the destination, etc.). Upon detecting the completion of the transportation service, the computing system 505 can determine the concluding object-check action by determining that an alternative object itinerary has been created (e.g., during a previous object-check action). The computing system 505 can determine that the rider chose an alternative recovery method for the object(s) separated from the rider during one or more of the previous transportation leg(s) of the multi-modal transportation itinerary. The computing system 505 can further determine the current status of the alternative recovery method based at least in part on additional object location data 530 and/or the object itinerary. The current status of the separated object can include a current object location, an estimated time for delivery, and/or an estimated time for return of the separated object to the rider. The computing system 505 can provide the current status of the object(s) for display via the rider device.

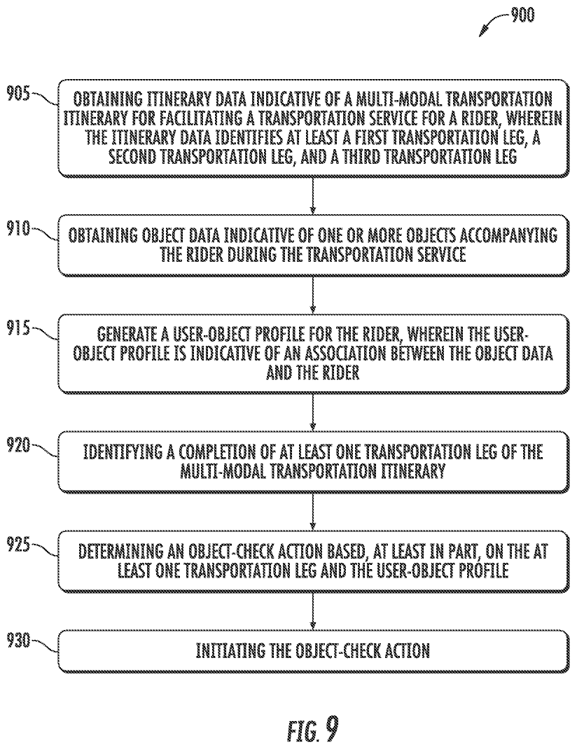

FIG. 9 depicts a flow diagram 900 of an example method for initiating an object check according to example embodiments of the present disclosure. One or more portion(s) of the method 900 can be implemented by a computing system that includes one or more computing devices such as, for example, the computing systems described with reference to the other figures (e.g., service entity computing system(s) 102, computing system 505, etc.). Each respective portion of the method 900 can be performed by any (or any combination) of one or more computing devices. Moreover, one or more portion(s) of the method 900 can be implemented as an algorithm on the hardware components of the device(s) described herein (e.g., as in FIGS. 1, 5, 11, etc.), for example, to initiate an object check. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 9 is described with reference to elements/terms described with respect to other systems and figures for exemplary illustrated purposes and is not meant to be limiting. One or more portions of method 900 can be performed additionally, or alternatively, by other systems.

At 905, the method 900 can include obtaining itinerary data indicative of a multi-modal transportation itinerary for facilitating a transportation service for a rider. For example, a computing system (e.g., service entity computing system(s) 102, computing system 505, etc.) can obtain the itinerary data indicative of a multi-modal transportation itinerary for facilitating a transportation service for a rider. The itinerary data can identify at least a first transportation leg, a second transportation leg, and/or a third transportation leg.

At 910, the method 900 can include obtaining object data indicative of one or more objects accompanying the rider during the transportation service. For example, the computing system (e.g., service entity computing system(s) 102, computing system 505, etc.) can obtain the object data indicative of one or more objects accompanying the rider during the transportation service.

For example, the computing system can obtain request data indicative of a request for the transportation service for the rider. The request data can include first quantity data and first attribute data. The first quantity data can be indicative of a first number of objects accompanying the rider. The first attribute data can be indicative of one or more object attributes for each object of the first number of objects. In addition, or alternatively, the computing system can obtain sensor data including second quantity data and second attribute data. The second quantity data can be indicative of a second number of objects accompanying the rider. The second attribute data can be indicative of one or more object attributes for each object of the second number of objects. The computing system can determine an initial object-check action before the transportation service based, at least in part, on the request data and the sensor data and initiate the initial object-check action.

At 915, the method 900 can include generating a user-object profile for the rider. For example, the computing system (e.g., service entity computing system(s) 102, computing system 505, etc.) can generate the user-object profile for the rider. The user-object profile can be indicative of an association between the object data and the rider.

At 920, the method 900 can include identifying a completion of at least one transportation leg of the multi-modal transportation itinerary. For example, the computing system (e.g., service entity computing system(s) 102, computing system 505, etc.) can identify the completion of at least one transportation leg of the multi-modal transportation itinerary.

At 925, the method 900 can include determining an object-check action based, at least in part, on the at least one transportation leg and the user-object profile. For example, the computing system (e.g., service entity computing system(s) 102, computing system 505, etc.) can determine the object-check action based, at least in part, on the at least one transportation leg and the user-object profile.

For example, the computing system can obtain additional object data. The additional object data can include sensor data obtained via one or more sensors associated with the at least one transportation leg. For example, the at least one transportation leg can include a ground transportation leg. The ground transportation leg can include a ground transportation from an origin location to a transportation facility via a ground vehicle. In such a case, the one or more sensors can include one or more vehicle sensors of the ground vehicle or one or more facility sensors of the transportation facility.

The computing system can determine object location data indicative of a relative location of at least one of the one or more objects to the rider based, at least in part, on the additional object data, the user-object profile, and the at least one transportation leg. And, the computing system can determine the object-check action based, at least in part, on the object location data. The object-check action can include providing data indicative of the relative location of the at least one object to one or more computing devices associated with one or more participants of the at least one transportation leg. For instance, the one or more participants of the at least one transportation leg can include at least one of the rider, a vehicle operator of a ground vehicle, or transportation facility personnel associated with a transportation facility.

In some implementations, the relative location can be outside an acceptable location range. In such a case, the object-check action can include blocking the commencement of a transportation leg subsequent to the at least one transportation leg. In addition, or alternatively, the object-check action can include generating recovery data including one or more alternative object transportation options and providing the one or more alternative object transportation options to a rider device associated with the rider. The relative location can within the acceptable relative location range. In such a case, the object-check action can include providing for display a portion of the itinerary data indicative of a transportation leg subsequent to the at least one transportation leg of the multi-modal transportation itinerary.

At 930, the method 900 can include initiating the object-check action. For example, the computing system (e.g., service entity computing system(s) 102, computing system 505, etc.) can initiate the object-check action.

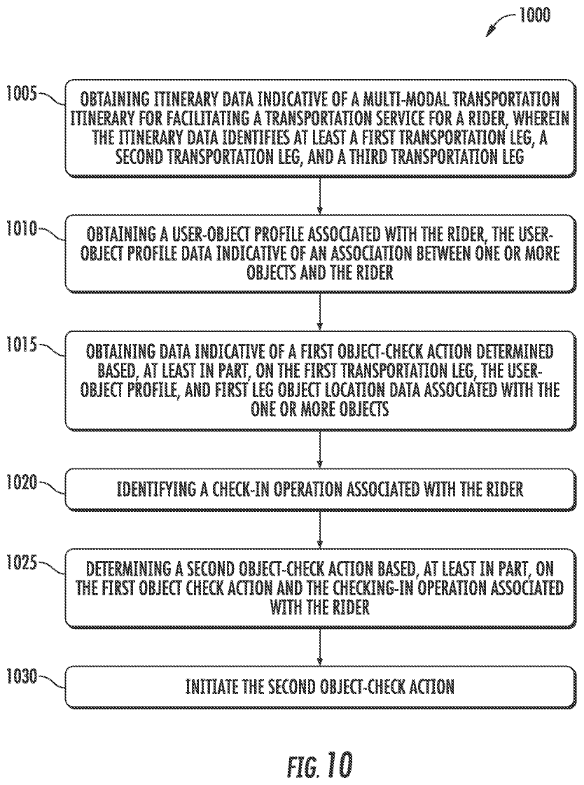

FIG. 10 depicts another flow diagram 1000 of another example method for initiating an object check according to example embodiments of the present disclosure. One or more portion(s) of the method 1000 can be implemented by a computing system that includes one or more computing devices such as, for example, the computing systems described with reference to the other figures (e.g., service entity computing system(s) 102, computing system 505, etc.). Each respective portion of the method 1000 can be performed by any (or any combination) of one or more computing devices. Moreover, one or more portion(s) of the method 1000 can be implemented as an algorithm on the hardware components of the device(s) described herein (e.g., as in FIGS. 1, 5, 11, etc.), for example, to initiate an object check. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 10 is described with reference to elements/terms described with respect to other systems and figures for exemplary illustrated purposes and is not meant to be limiting. One or more portions of method 1000 can be performed additionally, or alternatively, by other systems.

At 1005, the method 1000 can include obtaining itinerary data indicative of a multi-modal transportation itinerary for facilitating a transportation service for a rider. For example, a computing system (e.g., service entity computing system(s) 102, computing system 505, etc.) can obtain the itinerary data indicative of a multi-modal transportation itinerary for facilitating a transportation service for a rider. The itinerary data can identify at least a first transportation leg, a second transportation leg, and/or a third transportation leg. For example, the rider can be one of a group of riders associated with the multi-modal transportation itinerary. In such a case, the object can be one of a plurality of objects accompanying the group of riders.

At 1010, the method 1000 can include obtaining a user-object profile associated with the rider. For example, the computing system (e.g., service entity computing system(s) 102, computing system 505, etc.) can obtain the user-object profile associated with the rider. The user-object profile data can be indicative of an association between one or more objects and the rider.

At 1015, the method 1000 can include obtaining data indicative of a first object-check action determined based, at least in part, on the first transportation leg, the user-object profile, and first leg object location data associated with the one or more objects. For example, the computing system (e.g., service entity computing system(s) 102, computing system 505, etc.) can obtain the data indicative of the first object-check action determined based, at least in part, on the first transportation leg, the user-object profile, and first leg object location data associated with the one or more objects. For example, the first leg object location data can be indicative of a relative location of the object after the first transportation leg of the multi-modal transportation itinerary.

At 1020, the method 1000 can include identifying a check-in operation associated with the rider. For example, the computing system (e.g., service entity computing system(s) 102, computing system 505, etc.) can identify the check-in operation associated with the rider.

At 1025, the method 1000 can include determining a second object-check action based, at least in part, on the first object-check action and the checking-in operation associated with the rider. For example, the computing system (e.g., service entity computing system(s) 102, computing system 505, etc.) can determine the second object-check action based, at least in part, on the first object-check action and the checking-in operation associated with the rider.

At 1030, the method 1000 can include initiating the second object-check action. For example, the computing system (e.g., service entity computing system(s) 102, computing system 505, etc.) can initiate the second object-check action. For example, the second object-check action can include providing data indicative of the relative location of the object to at least one device associated with the checking-in operation. In some implementations, the computing system can obtain response data indicative of an intent to proceed with the checking-in operation without the object or an intent to retrieve the object.

For instance, the response data can be indicative of the intent to proceed with the checking-in operation without the object. In such a case, the second object-check action can include generating recovery data including one or more alternative object transportation options for transporting the object to the rider.

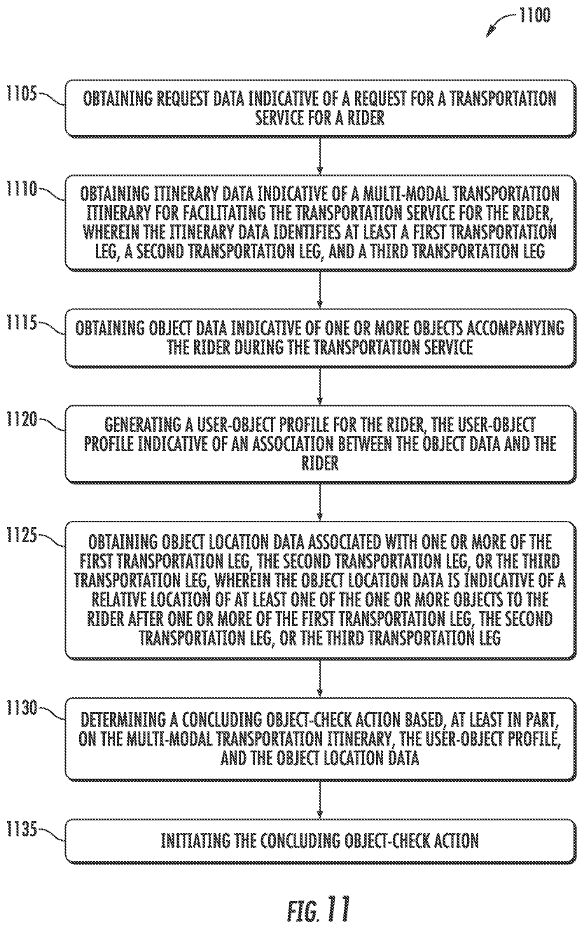

FIG. 11 depicts a third flow diagram 1100 of another example method for initiating an object check according to example embodiments of the present disclosure. One or more portion(s) of the method 1100 can be implemented by a computing system that includes one or more computing devices such as, for example, the computing systems described with reference to the other figures (e.g., service entity computing system(s) 102, computing system 505, etc.). Each respective portion of the method 1100 can be performed by any (or any combination) of one or more computing devices. Moreover, one or more portion(s) of the method 1100 can be implemented as an algorithm on the hardware components of the device(s) described herein (e.g., as in FIGS. 1, 5, 11, etc.), for example, to initiate an object check. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 11 is described with reference to elements/terms described with respect to other systems and figures for exemplary illustrated purposes and is not meant to be limiting. One or more portions of method 1100 can be performed additionally, or alternatively, by other systems.

At 1105, the method 1100 can include obtaining itinerary data indicative of a request for a transportation service for a rider. For example, a computing system (e.g., service entity computing system(s) 102, computing system 505, etc.) can obtain the itinerary data indicative of the request for the transportation service for the rider.

At 1110, the method 1100 can include obtaining itinerary data indicative of a multi-modal transportation itinerary for facilitating the transportation service for the rider. For example, the computing system (e.g., service entity computing system(s) 102, computing system 505, etc.) can obtain the itinerary data indicative of the multi-modal transportation itinerary for facilitating the transportation service for the rider. The itinerary data can identify at least a first transportation leg, a second transportation leg, and a third transportation leg.

At 1115, the method 1100 can include obtaining object data indicative of one or more objects accompanying the rider during the transportation service. For example, the computing system (e.g., service entity computing system(s) 102, computing system 505, etc.) can obtain the object data indicative of the one or more objects accompanying the rider during the transportation service.

At 1120, the method 1100 can include generating a user-object profile for the rider. For example, the computing system (e.g., service entity computing system(s) 102, computing system 505, etc.) can generate the user-object profile for the rider. The user-object profile can identify an association between the object data and the rider.

At 1125, the method 1100 can include obtaining object location data associated with one or more of the first transportation leg, the second transportation leg, or the third transportation leg. For example, the computing system (e.g., service entity computing system(s) 102, computing system 505, etc.) can obtain object location data associated with one or more of the first transportation leg, the second transportation leg, or the third transportation leg. The object location data can be indicative of a relative location of at least one of the one or more objects to the rider after one or more of the first transportation leg, the second transportation leg, or the third transportation leg.

At 1130, the method 1100 can include determining a concluding object-check action based, at least in part, on the multi-modal transportation itinerary, the user-object profile, and the object location data. For example, the computing system (e.g., service entity computing system(s) 102, computing system 505, etc.) can determine the concluding object-check action based, at least in part, on the multi-modal transportation itinerary, the user-object profile, and the object location data.

For example, the relative location of the object can be outside of an acceptable relative location range. For instance, the computing system can determine that the object is a separated object that has been separated from the rider during the transportation service based, at least in part, on the object location data. The computing system can obtain recovery data including one or more alternative object transportation options for the separated object. The computing system can generate an object itinerary for the separated object based, at least in part, on the itinerary data and the recovery data. And, the computing system can provide for display, via a rider device associated with the rider, data indicative of the object itinerary.

For instance, the computing system can identify a completion of a final transportation leg of the multi-modal transportation itinerary. The computing system can obtain data indicative of a current location of the separated object. And, the computing system can provide for display, via the rider device, the data indicative of a current location of the separated object.

At 1135, the method 1100 can include initiating the concluding object-check action. For example, the computing system (e.g., service entity computing system(s) 102, computing system 505, etc.) can initiate the concluding object-check action.

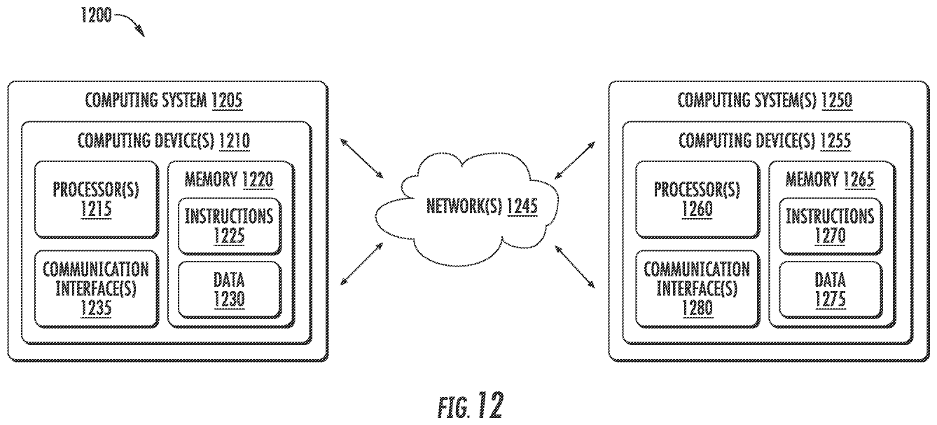

FIG. 12 depicts example system components of an example system 1200 according to example embodiments of the present disclosure. The example system 1200 can include the computing system 1205 (e.g., service entity computing system 102, computing system 505, etc.) and the computing system 1250 (e.g., computing device(s) 140, 150, 160, 170, 190, etc.), etc. that are communicatively coupled over one or more network(s) 1245.

The computing system 1205 can include one or more computing device(s) 1210. The computing device(s) 1210 of the computing system 1205 can include processor(s) 1215 and a memory 1220. The one or more processors 1215 can be any suitable processing device (e.g., a processor core, a microprocessor, an ASIC, a FPGA, a controller, a microcontroller, etc.) and can be one processor or a plurality of processors that are operatively connected. The memory 1220 can include one or more non-transitory computer-readable storage media, such as RAM, ROM, EEPROM, EPROM, one or more memory devices, flash memory devices, etc., and combinations thereof.

The memory 1220 can store information that can be accessed by the one or more processors 1215. For instance, the memory 1220 (e.g., one or more non-transitory computer-readable storage mediums, memory devices) can include computer-readable instructions 1225 that can be executed by the one or more processors 1215. The instructions 1225 can be software written in any suitable programming language or can be implemented in hardware. Additionally, or alternatively, the instructions 1225 can be executed in logically and/or virtually separate threads on processor(s) 1215.

For example, the memory 1220 can store instructions 1225 that when executed by the one or more processors 1215 cause the one or more processors 1215 to perform operations such as any of the operations and functions for which the computing systems are configured, as described herein.

The memory 1220 can store data 1230 that can be obtained, received, accessed, written, manipulated, created, and/or stored. The data 1230 can include, for instance, itinerary data, user-object profile data, initial object data, additional object data, rider location data, object location data, etc. as described herein. In some implementations, the computing device(s) 1210 can obtain from and/or store data in one or more memory device(s) that are remote from the computing system 1205 such as one or more memory devices of the computing system 1250.

The computing device(s) 1210 can also include a communication interface 1235 used to communicate with one or more other system(s) (e.g., computing system 1250). The communication interface 1235 can include any circuits, components, software, etc. for communicating via one or more networks (e.g., 1245). In some implementations, the communication interface 1235 can include for example, one or more of a communications controller, receiver, transceiver, transmitter, port, conductors, software and/or hardware for communicating data/information.

The computing system 1250 can include one or more computing devices 1255. The one or more computing devices 1255 can include one or more processors 1260 and a memory 1265. The one or more processors 1260 can be any suitable processing device (e.g., a processor core, a microprocessor, an ASIC, a FPGA, a controller, a microcontroller, etc.) and can be one processor or a plurality of processors that are operatively connected. The memory 1265 can include one or more non-transitory computer-readable storage media, such as RAM, ROM, EEPROM, EPROM, one or more memory devices, flash memory devices, etc., and combinations thereof.

The memory 1265 can store information that can be accessed by the one or more processors 1260. For instance, the memory 1265 (e.g., one or more non-transitory computer-readable storage mediums, memory devices) can store data 1275 that can be obtained, received, accessed, written, manipulated, created, and/or stored. The data 1275 can include, for instance, location data, user interface data, recovery data, and/or other data or information described herein. In some implementations, the computing system 1250 can obtain data from one or more memory device(s) that are remote from the computing system 1250.

The memory 1265 can also store computer-readable instructions 1270 that can be executed by the one or more processors 1260. The instructions 1270 can be software written in any suitable programming language or can be implemented in hardware. Additionally, or alternatively, the instructions 1270 can be executed in logically and/or virtually separate threads on processor(s) 1260. For example, the memory 1265 can store instructions 1270 that when executed by the one or more processors 1260 cause the one or more processors 1260 to perform any of the operations and/or functions described herein, including, for example, any of the operations and functions of the devices described herein, and/or other operations and functions.

The computing device(s) 1255 can also include a communication interface 1280 used to communicate with one or more other system(s). The communication interface 1280 can include any circuits, components, software, etc. for communicating via one or more networks (e.g., 1245). In some implementations, the communication interface 1280 can include for example, one or more of a communications controller, receiver, transceiver, transmitter, port, conductors, software and/or hardware for communicating data/information.

The network(s) 1245 can be any type of network or combination of networks that allows for communication between devices. In some embodiments, the network(s) 1245 can include one or more of a local area network, wide area network, the Internet, secure network, cellular network, mesh network, peer-to-peer communication link and/or some combination thereof and can include any number of wired or wireless links. Communication over the network(s) 1245 can be accomplished, for instance, via a network interface using any type of protocol, protection scheme, encoding, format, packaging, etc.

FIG. 12 illustrates one example system 1200 that can be used to implement the present disclosure. Other computing systems can be used as well. Computing tasks discussed herein as being performed at an operations computing system can instead be performed remote from the operations computing system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system, the computing system comprising:
one or more processors; and
one or more tangible, non-transitory, computer readable media that collectively store instructions that when executed by the one or more processors cause the computing system to perform operation, the operations comprising:
obtaining itinerary data indicative of a multi-modal transportation itinerary for facilitating a transportation service for a rider, wherein the itinerary data identifies at least a first transportation leg, a second transportation leg, and a third transportation leg;
obtaining object data indicative of one or more objects accompanying the rider during the transportation service;
generating a user-object profile for the rider, the user-object profile indicative of an association between the object data and the rider;
identifying a completion of at least one transportation leg of the multi-modal transportation itinerary;
determining an object-check action based, at least in part, on the at least one transportation leg and the user-object profile; and
initiating the object-check action.

2. The computing system of claim 1, wherein determining the object-check action comprises:
obtaining, by the computing system, additional object data;
determining, by the computing system, object location data indicative of a relative location of at least one of the one or more objects to the rider based, at least in part, on the additional object data, the user-object profile, and the at least one transportation leg; and
determining, by the computing system, the object-check action based, at least in part, on the object location data.

3. The computing system of claim 2, wherein the relative location is outside an acceptable relative location range, and wherein the object-check action comprises:
blocking, by the computing system, a commencement of a transportation leg subsequent to the at least one transportation leg.

4. The computing system of claim 2, wherein the relative location is outside an acceptable relative location range, and wherein the object-check action comprises:
generating, by the computing system, recovery data comprising one or more alternative object transportation options; and
providing, by the computing system, the one or more alternative object transportation options to a rider device associated with the rider.

5. The computing system of claim 2, wherein the relative location is within an acceptable relative location range, and wherein the object-check action comprises:
providing for display, by the computing system, a portion of the itinerary data indicative of a transportation leg subsequent to the at least one transportation leg of the multi-modal transportation itinerary.

6. The computing system of claim 2, wherein the additional object data comprises sensor data obtained via one or more sensors associated with the at least one transportation leg.

7. The computing system of claim 6, wherein the at least one transportation leg is a ground transportation leg, wherein the ground transportation leg comprises a ground transportation from an origin location to a transportation facility via a ground vehicle, and wherein the one or more sensors comprise one or more vehicle sensors of the ground vehicle or one or more facility sensors of the transport facility.

8. The computing system of claim 7, wherein the object-check action comprises:
providing, by the computing system, data indicative of the relative location of the at least one object to one or more computing devices associated with one or more participants of the at least one transportation leg, the one or more participants of the at least one transportation leg comprising at least one of the rider, a vehicle operator of the ground vehicle, or transportation facility personnel associated with the transportation facility.

9. The computing system of claim 1, further comprising:
obtaining, by the computing system, request data indicative of a request for the transportation service for the rider, wherein the request data comprises first quantity data and first attribute data, wherein the first quantity data is indicative of a first number of objects accompanying the rider, and wherein the first attribute data is indicative of one or more object attributes for each object of the first number of objects.

10. The computing system of claim 9, further comprising:
obtaining, by the computing system, sensor data comprising second quantity data and second attribute data, wherein the second quantity data is indicative of a second number of objects accompanying the rider, and wherein the second attribute data is indicative of one or more object attributes for each object of the second number of objects.

11. The computing system of claim 10, further comprising:
determining, by the computing system, an initial object-check action before the transportation service based, at least in part, on the request data and the sensor data; and
initiating, by the computing system, the initial object-check action.

12. A computer-implemented method, the method comprising:
obtaining, by a computing system comprising one or more computing devices, itinerary data indicative of a multi-modal transportation itinerary for facilitating a transport of a rider, wherein the itinerary data identifies at least a first transportation leg and a second transportation leg;
obtaining, by the computing system, user-object profile data associated with the rider, the user-object profile data indicative of an association between an object and the rider;
obtaining, by the computing system, data indicative of a first object-check action determined based, at least in part, on the first transportation leg, the user-object profile data, and first leg object location data associated with the object;
identifying, by the computing system, a checking-in operation associated with the rider;
determining, by the computing system, a second object-check action based, at least in part, on the first object-check action and the checking-in operation associated with the rider; and
initiating, by the computing system, the second object-check action.

13. The computer-implemented method of claim 12, wherein the first leg object location data is indicative of a relative location of the object after the first transportation leg of the multi-modal transportation itinerary.

14. The computer-implemented method of claim 13, wherein the second object-check action comprises:
providing, by the computing system, data indicative of the relative location of the object to at least one device associated with the checking-in operation.

15. The computer-implemented method of claim 14, further comprising:
obtaining, by the computing system, response data indicative of an intent to proceed with the checking-in operation without the object or an intent to retrieve the object.

16. The computer-implemented method of claim 15, wherein the response data is indicative of the intent to proceed with the checking-in operation without the object, and wherein the second object-check action further comprises:
generating, by the computing system, recovery data comprising one or more alternative object transportation options for transporting the object to the rider.

17. The computer-implemented method of claim 12, wherein the rider is one of a group of riders associated with the multi-modal transportation itinerary, and wherein the object is one of a plurality of objects accompanying the group of riders.

18. One or more tangible, non-transitory computer-readable media storing computer-readable instructions that when executed by one or more processors cause the one or more processors to perform operations, the operations comprising:
obtaining itinerary data indicative of a multi-modal transportation itinerary for facilitating a transportation service for a rider, wherein the itinerary data identifies at least a first transportation leg, a second transportation leg, and a third transportation leg;
obtaining object data indicative of an object accompanying the rider during the transportation service;
generating a user-object profile for the rider, the user-object profile indicative of an association between the object data and the rider;
obtaining object location data associated with one or more of the first transportation leg, the second transportation leg, or the third transportation leg, wherein the object location data is indicative of a relative location of the object to the rider;
determining a concluding object-check action based, at least in part, on the user-object profile and the object location data; and
initiating the concluding object-check action.

19. The one or more tangible, non-transitory computer-readable media of claim 18, wherein the relative location of the object is outside of an acceptable relative location range, and wherein determining the concluding object-check action comprises:
determining that the object is a separated object that has been separated from the rider during the transportation service based, at least in part, on the object location data;
obtaining recovery data comprising one or more alternative object transportation options for the separated object;
generating an object itinerary for the separated object based, at least in part, on the itinerary data and the recovery data; and
providing for display, via a rider device associated with the rider, data indicative of the object itinerary.

20. The one or more tangible, non-transitory computer-readable media of claim 19, wherein determining the concluding object-check action further comprises:
identifying a completion of a final transportation leg of the multi-modal transportation itinerary;
obtaining data indicative of a current location of the separated object; and
providing for display, via the rider device, the data indicative of a current location of the separated object.
